(19) United States
(12) Patent Application Publication
(10) Pub. No.: US 2009/0196658 A1
(43) Pub. Date: Aug. 6, 2009

(54) TONER, DEVELOPER, IMAGE FORMING METHOD, IMAGE FORMING APPARATUS AND PROCESS CARTRIDGE

(76) Inventor: Hideki SUGIURA, Numazu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/352,112

(22) Filed: Jan. 12, 2009

(30) Foreign Application Priority Data
Feb. 1, 2008 (JP) 2008-023205

(51) Int. Cl. G03G 15/08; G03G 9/087

(52) U.S. Cl. 399/252; 430/108.3; 430/125.5

(57) ABSTRACT

A toner having a weight-average particle diameter of from 2 to 7 μm and a circularity of from 0.95 to 1.00, including a colorant; a binder resin; and at least one oxidized particulate material, comprising a silicon element, wherein the oxidized particulate material has a number-average particle diameter (Dn) of from 30 to 80 nm; a standard deviation rate of the particle diameter distribution (the standard deviation/Dn×100) of from 0 to 10%; a shape factor SF1 of from 100 to 130; a standard deviation rate of the SF1 (the standard deviation/SF1×100) of from 0 to 10%; a shape factor SF2 of from 100 to 125; and a standard deviation rate of the SF2 (the standard deviation/SF2×100) of from 0 to 10%.

### BACKGROUND OF THE INVENTION

1. Field of the Invention

The present invention relates to a toner, a developer, an image forming method, an image forming apparatus and a process cartridge.

2. Discussion of the Background

Typical electrophotographic or electrostatic printing image forming processes include a developing process of uniformly charging a photoconductive insulative layer, irradiating the insulative layer, dissipating a charge on the irradiated part thereof to form an electrostatic latent image thereon, and attaching a fine powder toner having a charge to the latent image to form a visual image; a transfer process of transferring the visual image onto a receiving material such as a transfer paper; and a fixing process of fixing the visual image thereon upon application of heat or pressure (typically with a heat roller). A two-component developer including a carrier and a toner, and a one-component developer (magnetic or non-magnetic toner) not needing a carrier are known as a developer developing an electrostatic latent image on a latent image bearer. An intermediate transfer method of sequentially transferring each color toner image formed on a photoreceptor onto an intermediate transferer to form an overlapped color image thereon and transferring again the overlapped color image onto a paper at a time is conventionally used as a full-color image forming apparatus.

A toner for use in such electrophotographic or electrostatic printing image forming processes includes a binder resin and a colorant as main components, and additives such as a charge controlling agent and an offset inhibitor if desired, and is required to have various performances. For example, in the developing process, the toner and the binder resin have to keep charge quantity suitable for a copier or a printer without being affected by surrounding environments such as a temperature and a humidity to adhere to the electrostatic latent image. In addition, in the fixing process using a heat roller, they have to have offset resistance not to adhere to the heat roller having a temperature of from 100 to 230° C. and good fixability on papers. The toner is further required to be anti-blocking when stored in a copier.

Recently, electrophotographic images having higher quality are studied from a variety of different angles, and particularly a toner having a smaller diameter and more sphericity is being thought to noticeably effective for the higher quality of the images. However, the smaller the diameter, the lower the transferability, and the resultant images are likely to be poor. On the other hand, Japanese published unexamined application No. 9-258474 discloses that a toner is ensphered to improve its transferability. However, the cleanability of the ensphered toner deteriorates as an adverse effect.

Under such circumstances, color copiers and printers are required to produce images at higher speed. Japanese published unexamined application No. 5-341617 discloses a tandem method which is effective for the higher speed image production. The tandem method sequentially transfers single-color images formed by image forming units onto a single transfer paper conveyed by a transfer belt while overlapping the single-color images to form a full-color image on the transfer paper. Full-color image forming apparatuses using the tandem method can use various transfer papers, and produce high quality full-color images at high speed. Particularly, no other full-color image forming apparatus can produce full-color images at such high speed. On the other hand, trials to produce higher quality images at higher speed with a spherical toner are made. In order to make the image forming apparatuses using the tandem method produce images at further higher speed, a paper needs to pass a transfer position for a shorter time and transfer pressure needs increasing. However, when the transfer pressure is increased, the toner agglutinates by the pressure and does not transfer well, resulting in production of hollow images.

In addition, Japanese published unexamined applications Nos. 2004-212789, 2006-61519 and 2007-79246 disclose methods of mixing external additives such as oxidized particulate materials with a toner for the purpose of improving the cleanability, fluidity and chargeability of the toner. The oxidized particulate materials are treated with specific silane coupling agents, titanate coupling agents, silicone oils, organic acids, etc. or coated with specific resins if desired for the purpose of improving the hydrophobicity and chargeability thereof. Specific examples of the oxidized particulate materials include silicon dioxide (silica), titanium dioxide (titania), aluminum oxide, zinc oxide, magnesium oxide, cerium oxide, iron oxide, copper oxide and tin oxide, etc.

However, the oxidized particulate materials typically have infinite forms, and they are required to have suitable forms and adherence on the surface of a toner to effectively fulfill functions as the external additives. Further, robust image forming apparatuses applicable to recent various usage environments and image modes of users.

The oxidized particulate materials are known to negatively affect the fixability of a toner due to their physical and chemical properties, and oxidized particulate materials not preventing toners from fixing are demanded.

Because of these reasons, a need exists for a toner having stress resistance, improved fluidity, properly free oxidized particulate materials, improved cleanability owing to reduction of non-electrostatic adherence, improved filming (contamination) resistance over a photoreceptor, good heat and humidity resistance, low-temperature fixability and sufficiently high fixing strength.

### SUMMARY OF THE INVENTION

Accordingly, an object of the present invention is to provide a toner having stress resistance, improved fluidity, properly free oxidized particulate materials, improved cleanability owing to reduction of non-electrostatic adherence, improved filming (contamination) resistance over a photoreceptor, good heat and humidity resistance, low-temperature fixability and sufficiently high fixing strength.

Another object of the present invention is to provide a two-component developer including the toner.

A further object of the present invention is to provide an image forming method using the toner or the developer.

Another object of the present invention is to provide an image forming apparatus holding the toner or the developer.

A further object of the present invention is to provide a process cartridge holding the toner or the developer.

These objects and other objects of the present invention, either individually or collectively, have been satisfied by the discovery of a toner having a weight-average particle diameter of from 2 to 7 μm and a circularity of from 0.95 to 1.00, comprising:

a colorant;

a binder resin; and

at least one oxidized particulate material, comprising a silicon element,

wherein the oxidized particulate material has a number-average particle diameter (Dn) of from 30 to 80 nm; a standard deviation rate of the particle diameter distribution (the standard deviation/Dn×100) of from 0 to 10%; a shape factor SF1 of from 100 to 130; a standard deviation rate of the SF1 (the standard deviation/SF1×100) of from 0 to 10%; a shape factor SF2 of from 100 to 125; and a standard deviation rate of the SF2 (the standard deviation/SF2×100) of from 0 to 10%.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view illustrating an embodiment of the image forming apparatus of the present invention;

FIG. 2 is a schematic view illustrating another embodiment of the image forming apparatus of the present invention;

FIG. 3 is a schematic view illustrating a further embodiment of the image forming apparatus of the present invention;

FIG. 4 is a schematic view illustrating another embodiment of the image forming apparatus of the present invention;

FIG. 5 is a schematic view illustrating a further embodiment of the image forming apparatus of the present invention;

FIG. 6 is a schematic view illustrating another embodiment of the image forming apparatus of the present invention; and

FIG. 7 is a schematic view illustrating an embodiment of the process cartridge of the present invention.

### DETAILED DESCRIPTION OF THE INVENTION

The present invention provides a toner having stress resistance, improved fluidity, properly free oxidized particulate materials, improved cleanability owing to reduction of non-electrostatic adherence, improved filming (contamination) resistance over a photoreceptor, good heat and humidity resistance, low-temperature fixability and sufficiently high fixing strength. More particularly, the present invention relates to a toner having a weight-average particle diameter of from 2 to 7 μm and a circularity of from 0.95 to 1.00, comprising:

a colorant;

a binder resin; and

at least one oxidized particulate material, comprising a silicon element,

wherein the oxidized particulate material has a number-average particle diameter (Dn) of from 30 to 80 nm; a standard deviation rate of the particle diameter distribution (the standard deviation/Dn×100) of from 0 to 10%; a shape factor SF1 of from 100 to 130; a standard deviation rate of the SF1 (the standard deviation/SF1×100) of from 0 to 10%; a shape factor SF2 of from 100 to 125; and a standard deviation rate of the SF2 (the standard deviation/SF2×100) of from 0 to 10%.

The mechanism is not yet clarified, but the followings are assumed from some analysis data. The oxidized particulate materials having such particle diameters, particle diameter distributions, shapes and shape distributions are difficult to be buried in a toner and exert an effect of imparting fluidity to the toner as an external additive.

Further, the oxidized particulate materials lower the electrostatic adherence of a toner, and less release therefrom and less cause filming (contamination) over photoreceptors. The resultant toner has good heat and humidity resistance owing to a spacer effect of the oxidized particulate materials, and good low-temperature fixability and fixing strength owing to a low content thereof.

When the oxidized particulate materials have a particle diameter less than 30 nm, the oxidized particulate materials do not have sufficient spacer effects on the surface of a toner. When greater than 80 nm, the oxidized particulate materials are difficult to impart sufficient fluidity to a toner having a weight-average particle diameter of from 2 to 7 μm. Further, they are likely to release from the surface of a toner, resulting in filming (contamination) over photoreceptors.

Further, the oxidized particulate materials having a standard deviation rate of the particle diameter distribution (the standard deviation/Dn×100) of from 0 to 10% have very sharp particle diameter distributions and exert spacer effects more. When greater than 10%, adherence of a toner to another toner, to a photoreceptor and to a carrier are uneven, resulting in insufficient spacer effects.

Further, the oxidized particulate materials having a shape factor SF1 of from 100 to 130; a standard deviation rate of the SF1 (the standard deviation/SF1×100) of from 0 to 10%; a shape factor SF2 of from 100 to 125; and a standard deviation rate of the SF2 (the standard deviation/SF2×100) of from 0 to 10% improve fluidity of a toner and their affinities for a toner, and prevents them from leaving therefrom. When SF1 and SF2 are out of the above-mentioned scopes, the oxidized particulate materials have indefinite shapes and do not evenly adhere to the surface of a toner. Therefore, the oxidized particulate materials do not stably contact a carrier, a transferer, a charger etc., resulting in deterioration of chargeability, cleanability and stress resistance of the toner.

The oxidized particulate materials having the above-mentioned shapes and including at least a silicon element (spherical particulate silica) may be prepared by heating and evaporating alkoxysilane and/or its partially hydrolyzed condensate to flow together with an inactive gas such as a nitrogen gas or spraying the alkoxysilane and/or its partially hydrolyzed condensate in a flame such as an oxyhydrogen flame to decompose. Then, it is important to strictly control materials, gas and temperatures to prepare the oxidized particulate materials having the above-mentioned shapes and particle diameter distributions.

Further, the oxidized particulate materials including a silicon element is preferably prepared by a sol-gel method. The oxidized particulate materials can be prepared thereby so as to have the above-mentioned shapes and particle diameters with ease.

The sol-gel method is a method of preparing particulate silica, including hydrolyzing and condensing tetraalkoxysilane in a water-alcohol mixed solvent under the presence of an acidic or alkaline catalyst at a room temperature. The method has advantages of being capable of preparing monodispersed microscopic spherical particles, having very few impurities originating from materials, solvents and catalysts, and having high productivity because hydrolyzing and condensing operation and apparatus are simple.

Other conventional oxidized particulate materials such as MgO, CaO, BaO, Al₂O₃, TiO₂ and SnO₂ can be used alone or in combination with SiO₂ as long as they have the specifications of the present invention. Particularly, a combination of silicon oxides and titanium oxides imparts good fluidity and chargeability to a toner, and durability thereto when strongly stirred.

Further, when the oxidized particulate materials are evenly dispersed at the surface of and inside a toner, the toner has even dielectric and resistivity properties. In the method of preparing the oxidized particulate materials, a solid solution particulate material occasionally becomes an unsaturated oxide depending on the oxidizing conditions, when the solid solution particulate material is oxidized as time passes, resulting in occasional deterioration of additives. In order to prevent the deterioration with age, reactive parts of the additives may be inactivated, and an organic silicon compound surface treatment agent and/or a titanium compound surface treatment agent are/is preferably used to inactivate them. The surface treatment is more preferably a hydrophobizing treatment.

Further, the oxidized particulate materials are preferably hydrophobized with hexamethyldisilazane. Even the relatively large oxidized particulate materials having a number-average particle diameter of from 30 to 80 nm and susceptible to the effect of outer environment can be sufficiently hydrophobized therewith. Consequently, the resultant developer stably resists to the environment and produces quality images.

The hydrophobizing treatment with hexamethyldisilazane includes hydrolyzing alkoxysilane in an alcohol (ethanol) solvent under the presence of an acidic catalyst to prepare a silica sol; gelating the silica sol to prepare a silica gel; drying the silica gel; and preliminarily and finally sintering the silica gel.

The alkoxysilane has a formula R²Si(OR³)₄₋ₐ, wherein R² and R³independently represent a monovalent hydrocarbon group having carbon atoms of from 1 to 4 and a represents an integer of from 0 to 4. Specific examples thereof include tetramethoxysilane, tetraethoxysilane, tetrapropoxysilane, tetrabutoxysilane, methyltrimethoxysilane, methyltriethoxysilane, methyltripropoxysilane, methyltributoxysilane, ethyltrimethoxysilane, ethyltripropoxysilane, ethyltributoxysilane, propyltrimethoxysilane, propyltriethoxysilane, butyltrimethoxysilane, butyltriethoxysilane, dimethyldimethoxysilane, dimethyldiethoxysilane, dimethyldipropoxysilane, dimethyldibutoxysilane, diethyldimethoxysilane, diethyldiethoxysilane, diethyldipropoxysilane, diethyldibutoxysilane, dipropyldimethoxysilane, dipropyldiethoxysilane, dibutyldimethoxysilane, dibutyldiethoxysilane, trimethylmethoxysilane, trimethylethoxysilane, trimethylpropoxysilane, triethylmethoxysilane, triethylethoxysilane, triethylpropoxysilane, triethylbutoxysilane, tripropylmethoxysilane, tripropylethoxysilane, tributylmethoxysilane, tributylethoxysilane, etc. Particularly, tetramethoxysilane and methyltrimethoxysilane are preferably used.

The oxidized particulate material of the present invention is preferably a hydrophobized spherical particulate silica, on the surface of which R¹₃SiO_{1/2} units are introduced such that the resultant toner is stably charged regardless of the environment. R¹ represents the same or a different monovalent hydrocarbon group having 1 to 8 carbon atoms such as a methyl group, an ethyl group, a propyl group, a butyl group, a pentyl group, a hexyl group, a heptyl group, an octyl group, a cyclohexyl group, a phenyl group, a vinyl group, an allyl group, etc. Particularly, a methyl group is preferably used.

The R¹₃SiO_{1/2} units may be introduced by known surface reforming methods for silica fine powder. Namely, after a silazane compound having a formula R¹₃SiNHSiR¹₃ is contacted to silica at 0 to 400° C. in a gas, liquid or solid phase under the presence of water, the silica is heated at 50 to 400° C. and excessive compounds are removed therefrom.

Specific examples having the formula R¹₃SiNHSiR¹₃ include hexamethyldisilazane, hexaethyldisilazane, hexapropyldisilazane, hexabutyldisilazane, hexapentyldisilazane, hexahexyldisilazane, hexaphenyldisilazane, divinyltetramethyldisilazane, etc. Particularly, hexamethyldisilazane is preferably used because of its hydrophobicity and removability after reform.

The oxidized particulate materials such as spherical particulate silica are externally or internally added to the toner of the present invention. The toner preferably includes the spherical particulate silica in an amount of from 0.01 to 20 parts by weight, and more preferably from 0.1 to 5 parts by weight. When less than 0.01 parts by weight, the toner does not have sufficient fluidity. When greater than 20 parts by weight, the chargeability and fixability of the toner deteriorate. The spherical particulate silica can be mixed with the toner by V-blender, Henschel Mixer, Ribbon Blender, automatic mortars, etc. The spherical particulate silica may adhere to the surface of the toner, be fusion-bonded thereto or included in the toner.

It is particularly important to control the particle diameter of the oxidized particulate materials adhering to the toner. This is because the oxidized particulate materials occasionally agglutinate and adhere to a toner or adhere only on concavities thereof. When the oxidized particulate materials having sufficiently controlled primary particle diameters form secondary aggregates, they have to be pulverized or broken when the toner is stirred. The toner needs to have a most suitable surface including mixing conditions of the oxidized particulate materials.

The particle diameters, distribution thereof, shapes and distribution thereof are directly measured through a scanning electron microscope (FE-SEM). When the FE-SEM is used, since a platinum deposition occasionally impairs the original shapes, deposition thickness is preferably about 1 nm. Alternatively, the particle diameters, distribution thereof, shapes and distribution thereof are more preferably measured by an ultrahigh resolution FE-SEM such as Ultra55 from Carl Zeiss, Inc. at a low accelerating voltage of from a few to 10 keV without deposition. At least 100 or more of the oxidized particulate materials are observed and the particle diameters, distribution thereof, shapes and distribution thereof are statically measured with an image processing software such as Image-Pro Plus from Media Cybernetics, Inc. Particularly, SF1 and SF2 are determined by the following formulae using Image-Pro Plus4.5.1 from Media Cybernetics, Inc. SF1 and SF2 are preferably determined thereby, but the FE-SEM, image analyzer and software are not limited to the above as long as a similar analytical result can be obtained.

SF1=(L²/A)×(π/4)×100

SF2=(P²/A)×(1/4π)×100

wherein L represents an absolute maximum length of a toner; A represents a projected area thereof; and P represents a maximum circumferential length thereof.

Both of SF1 and SF2 are 100 when a toner has true spherical form. The larger than 100, the more infinite. Particularly, SF1 represents the whole shape of a toner such as an ellipse or a sphere, and SF2 represents concavities and convexities of the surface of a toner.

The toner of the present invention may include inorganic particulate materials or hydrophobized inorganic particulate materials besides the oxidized particulate materials as external additives. The toner preferably includes at least one hydrophobized inorganic particulate material having a number-average particle diameter of from 1 to 100 nm, and more preferably from 1 to less than 30 nm. The external additive preferably has a specific surface area of from 20 to 500 m²/g when measured by a BET method.

Any known inorganic particulate materials or hydrophobized inorganic particulate materials can be used as the external additives. Specific examples of the external additives include particulate silica, hydrophobized silica, fatty acid metallic salts such as zinc stearate and aluminium stearate, metal oxides such as titania, alumina, tin oxide and antimony oxide, fluoropolymers, etc.

Particularly, the hydrophobized particulate silica, titania and alumina are preferably used. Specific examples of the particulate silica include HDK H 2000, HDK H 2000/4, HDK H2050EP and HVK21 from Hoechst AG; and R972, R974, RX200, RY200, R202, R805 and R812 from Nippon_Aerosil Co. Specific examples of the particulate titania include P-25 from Nippon Aerosil Co.; ST-30 and STT-65C-S from Titan Kogyo K.K.; TAF-140 from Fuji Titanium Industry Co., Ltd.; MT150W, MT-500B and MT-600b from Tayca Corp., etc. Specific examples of the hydrophobized particulate titanium oxide include T-805 from Nippon Aerosil Co.; STT-30A and STT-65S-S from Titan Kogyo K. K.; TAF-500T and TAF-1500T from Fuji Titanium Industry Co., Ltd.; MT-100S and MT100T from Tayca Corp.; IT-S from Ishihara Sangyo Kaisha Ltd., etc.

To prepare the hydrophobized oxidized particulate materials, particulate silica, particulate titania or particulate alumina, hydrophilic particulate materials are subjected to silane coupling agents such as methyltrimethoxy silane, methyltriethoxy silane and octylmethoxy silane. Inorganic fine particles optionally subjected to a silicone oil upon application of heat is preferably used.

Specific examples of the silicone oil include dimethyl silicone oil, methylphenyl silicone oil, chlorphenyl silicone oil, methylhydrogen silicone oil, alkyl modified silicone oil, fluorine modified silicone oil, polyether modified silicone oil, alcohol modified silicone oil, amino modified silicone oil, epoxy modified silicone oil, epoxy-polyether modified silicone oil, phenol modified silicone oil, carboxyl modified silicone oil, mercapto modified silicone oil, acryl modified silicone oil, methacryl modified silicone oil, α-methylstyrene modified silicone oil, etc. Specific examples of the inorganic fine particles include silica, alumina, titanium oxide, barium titanate, magnesium titanate, calcium titanate, strontium titanate, zinc oxide, tin oxide, quartz sand, clay, mica, sand-lime, diatomearth, chromiumoxide, ceriumoxide, rediron oxide, antimony trioxide, magnesium oxide, zirconium oxide, barium sulfate, barium carbonate, calcium carbonate, silicon carbide, silicon nitride, etc. Particularly, the silica and titanium dioxide are preferably used.

Specific examples of surface treatment agents for external additives including the oxidized particulate materials include silane coupling agents such as dialkyldihalogenated silane, trialkylhalogenated silane, alkyltrihalogenated silane and hexaalkyldisilazane; silylation agents; silane coupling agents having a fluorinated alkyl group; organic titanate coupling agents; aluminum coupling agents; silicone oil; and silicone varnish. Organic silicon compound surface treatment agents are more preferably used.

The toner preferably includes the external additives in an amount of from 0.1 to 5% by weight and more preferably from 0.3 to 3% by weight.

The weight-average particle diameter (D₄), the number-average diameter (Dn) and a ratio (D₄/Dn) of the weight-average particle diameter (D₄) to the number-average diameter (Dn) are measured by the following method.

The average particle diameter and the particle diameter distribution of a toner can be measured by a Coulter counter TA-II or Coulter Multisizer II from Coulter Electronics, Inc. as follows:

0.1 to 5 ml of a detergent, preferably alkylbenzene sulfonate is included as a dispersant in 100 to 150 ml of the electrolyte ISOTON R-II from Coulter Scientific Japan, Ltd., which is a NaCl aqueous solution including an elemental sodium content of 1%;

2 to 20 mg of a toner sample is included in the electrolyte to be suspended therein, and the suspended toner is dispersed by an ultrasonic disperser for about 1 to 3 min to prepare a sample dispersion liquid; and

a volume and a number of the toner particles for each of the following channels are measured by the above-mentioned measurer using an aperture of 100 μm to determine a weight distribution and a number distribution:

2.00 to 2.52 μm; 2.52 to 3.17 μm; 3.17 to 4.00 μm; 4.00 to 5.04 μm; 5.04 to 6.35 μm; 6.35 to 8.00 μm; 8.00 to 10.08 μm; 10.08 to 12.70 μm; 12.70 to 16.00 μm; 16.00 to 20.20 μm; 20.20 to 25.40 μm; 25.40 to 32.00 μm; and 32.00 to 40.30 μm.

The circularity of the toner of the present invention is determined by the following formula:

circularity=(circumferential length of a circle having the same area as a projected area of a particle/circumferential length of the projected area of the particle)×100%.

The circularity of the toner is measured by FPIA-2100 from SYSMEX CORPORATION and an analysis software FPIA-2100 Data Processing Program for FPIA version 00-10 was used. Specifically, 0.1 to 0.5 g of the toner and 0.5 ml of a surfactant (alkylbenzenesulfonate Neogen SC-A from Dai-ichi Kogyo Seiyaku Co., Ltd.) having a concentration of 10% by weight were mixed with a micro spatel in a glass beaker having a capacity of 100 ml, and 80 ml of ion-exchange water was added to the mixture. The mixture was dispersed by an ultrasonic disperser W-113MK-II from HONDA ELECTRONICS CO., LTD. for 3 min. The circularity of the toner was measured by FPIA-2100 until the dispersion has a concentration of from 5,000 to 15,000 pieces/μl, which is essential in terms of measurement reproducibility of the average circularity. In order to obtain the concentration, it is necessary to control added amounts of the surfactant and the toner. The amount of the surfactant depends on the hydrophobicity of the toner. When too much, bubbles cause noises. When short, the toner is not sufficiently wetted and not sufficiently dispersed. The amount of the toner depends on the particle diameter thereof. When small, the amount needs to be less. When large, the amount needs to be more. When the toner has a particle diameter of from 3 to 7 μm, the amount thereof is 0.1 to 0.5 g such that the dispersion has a concentration of from 5,000 to 15,000 pieces/μl.

The toner of the present invention preferably includes at least a polyester resin as a binder resin to have a compression strength and a good balance between retractility and adherence, i.e., more stable transferability, developability and fixability. Specific examples of the binder resin include styrene polymers and substituted styrene polymers such as polystyrene, poly-p-chlorostyrene and polyvinyltoluene; styrene copolymers such as styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers; and other resins such as polymethyl methacrylate, polybutylmethacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, chlorinated paraffin, paraffin waxes, etc. These resins are used alone or in combination. Particularly, the polyester resin is preferably used.

Various types of polyester resins can be used, and particularly a polyester resin prepared by reacting the following components (1) to (3) is preferably used:

(1) a member selected from the group consisting of bivalent carboxylic acids and their lower alkyl esters and anhydrides;

(2) diols having the following formula (1):

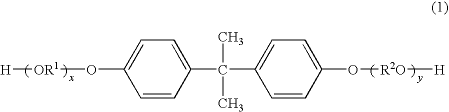

wherein R¹ and R² independently represent an alkylene group having 2 to 4 carbon atoms; and x and y independently represent an integer not less than one and a sum of them is from 2 to 16; and

(3) a member selected from the group consisting of tri- or more multivalent carboxylic acids and their lower alkyl esters and anhydrides, and tri- or more multivalent alcohols.

Specific examples of the bivalent carboxylic acids and their lower alkyl esters and anhydrides of (1) include terephthalic acids, isophthalic acids, sebacic acids, isodecyl succinic acids, maleic acids, fumaric acids and their monomethyl, monoethyl, dimethyl and diethylesters, and fumaric acid anhydrides and maleic acid anhydrides, etc. Particularly, terephthalic acids, isophthalic acids and their dimethylesters are preferably used in terms of anti-blocking and cost. These bivalent carboxylic acids and their lower alkyl esters and anhydrides largely influence upon the fixability and anti-blocking of the resultant toner. Namely, when aromatic terephthalic acids, isophthalic acids, etc. are used much, the resultant toner improves in its anti-blocking but deteriorates in its fixability although depending on the condensation. To the contrary, when sebacic acids, isodecyl succinic acids, maleic acids, fumaric acids, etc. are used much, the resultant toner improves in its fixability but deteriorates in its anti-blocking. Therefore, these bivalent carboxylic acids are used alone or in combination as desired in accordance with other monomer composition, ratio or condensation.

Specific examples of the diols having the formula (1) of (2) include polyoxypropylene-(n)-polyoxyethylene-(n′)-2,2-bis(4-hydroxy phenyl)propane, polyoxypropylene-(n)-2,2-bis(4-hydroxyphenyl)propane, polyoxyethylene-(n)-2,2-bis(4-hydroxyphenyl)propane, etc. Particularly, polyoxypropylene-(n)-2,2-bis(4-hydroxyphenyl)propane in which n is from 2.1 to 2.5 and polyoxyethylene-(n)-2,2-bis(4-hydroxyphenyl)propane in which n is from 2.0 to 2.5 are preferably used. The diols improves the glass transition temperature of the resultant toner and makes it easy to control the reaction. The diols also include fatty diols such as ethylene glycols, diethylene glycols, 1.2-butanediols, 1,3-butanedools, 1,4-butanediols, neopentyl glycols and propylene glycols.

Specific examples of the tri- or more multivalent carboxylic acids and their lower alkyl esters and anhydrides of (3) include 1,2,4-benzenetricarboxylic (trimellitic) acids, 2,5,7-naphthalenetricarboxylic acids, 1,2,4-naphthalenetricarboxylic acids, 1,2,4-butanetricarboxylic acids, 1,2,5-hexanetricarboxylic acids, 1,3-dicarboxyl-2-methyl-methylenecarboxypropane, tetra(methylenecarboxyl)methane, 1,2,7,8-octantetracarboxylic acids, empol trimer acids, and their anhydrides and lower alkyl esters, etc.

Specific examples of the tri- or more valent alcohols of (3) include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, 1,3,5-trihydroxybenzene, etc.

The content of the tri- or more multivalent carboxylic acids, their lower alkyl esters and anhydrides or tri- or more multivalent alcohols is preferably from 1 to 30% by mol. When less than 1% by mol, the resultant toner deteriorates in its offset resistance and durability. When greater than 30% by mol, the resultant toner deteriorates in its fixability.

Among these tri- or more multivalent carboxylic acids, their lower alkyl esters and anhydrides and tri- or more multivalent alcohols, benzenetricarboxylic acids and their esters or anhydrides are preferably used because the resultant toner has both fixability and offset resistance.

Methods of preparing these binder resins are not particularly limited, and include bulk polymerization methods, solution polymerization methods, emulsion polymerization methods, suspension polymerization methods and ester polymerization methods, etc.

Specific examples of the colorants for use in the toner of the present invention include any known dyes and pigments such as carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and their mixtures. The toner preferably includes the colorant in an amount of from 0.1 to 50 parts by weight based on total weight of the binder resin.

In the present invention, a masterbatch pigment prepared by preliminarily mixing and kneading the same amount of a resin and a pigment can be used for the purpose of improving affinity between the resin and pigment. The masterbatch is preferably prepared by kneading a resin soluble in a low-polarity solvent and a pigment upon application of heat without using an organic solvent because of having stable chargeability. Further, when water is used for wetting a dry powder pigment with a resin, the dispersibility of the pigment is more improved. Organic pigments used as colorants are typically hydrophobic, but an aggregate thereof can be soaked with water inside upon application of a strength because they are washed with water and dried while prepared. When a mixture of the aggregated pigment including water and a resin is kneaded by an open kneader at 100° C. or higher, the water in the aggregate instantly boils and swells to internally break the aggregate from within. The internal force more efficiently breaks the aggregate than a force externally applied thereto. Then, since the resin is heated at a melting point or higher, the resin has a low viscosity and efficiently wets the aggregate. At the same time, the resin is replaced with boiling water in the aggregate similarly to a flushing effect, and the resultant masterbatch pigment in which a pigment is dispersed in near-primary particle can be prepared. Further, while water evaporates, a kneaded mixture is deprived of a heat of evaporation and has relatively a low temperature and high viscosity, and therefore a shearing force is effectively applied to the aggregate. The open type kneaders for preparing a masterbatch pigment include convention two-roll mixers, three-roll mixers, open type Bunbury Mixers and continuous two-roll kneaders from Mitsui Mining Co., Ltd. The toner of the present invention may include a charge controlling agent when necessary. Specific examples of the charge controlling agent include known charge controlling agents such as Nigrosine dyes, triphenylmethane dyes, metal complex dyes including chromium, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid, salicylic acid derivatives, etc. Specific examples of the marketed products of the charge controlling agents include BONTRON 03 (Nigrosine dyes), BONTRON P-51 (quaternary ammonium salt), BONTRON S-34 (metal-containing azo dye), E-82 (metal complex of oxynaphthoic acid), E-84 (metal complex of salicylic acid), and E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative), COPY CHARGE NEG VP2036 and NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments and polymers having a functional group such as a sulfonate group, a carboxyl group, a quaternary ammonium group, etc. The content of the charge controlling agent is determined depending on the species of the binder resin used, whether or not an additive is added and toner manufacturing method (such as dispersion method) used, and is not particularly limited. However, the content of the charge controlling agent is typically from 0.1 to 10 parts by weight, and preferably from 0.2 to 5 parts by weight, per 100 parts by weight of the binder resin included in the toner. When the content is too high, the toner has too large charge quantity, and thereby the electrostatic force of a developing roller attracting the toner increases, resulting in deterioration of the fluidity of the toner and decrease of the image density of toner images.

The toner of the present invention can be used for a two-component developer in which the toner is mixed with a magnetic carrier. A content of the toner is preferably from 1 to 10 parts by weight per 100 parts by weight of the carrier. Suitable carriers for use in the two component developer include known carrier materials such as iron powders, ferrite powders, magnetite powders, magnetic resin carriers, which have a particle diameter of from about 20 to 200 μm. A surface of the carrier may be coated by a resin. Specific examples of such resins to be coated on the carriers include amino resins such as urea-formaldehyde resins, melamine resins, benzoguanamine resins, urea resins, and polyamide resins, and epoxy resins. In addition, vinyl or vinylidene resins such as acrylic resins, polymethylmethacrylate resins, polyacrylonitirile resins, polyvinyl acetate resins, polyvinyl alcohol resins, polyvinyl butyral resins, polystyrene resins, styrene-acrylic copolymers, halogenated olefin resins such as polyvinyl chloride resins, polyester resins such as polyethyleneterephthalate resins and polybutyleneterephthalate resins, polycarbonate resins, polyethylene resins, polyvinyl fluoride resins, polyvinylidene fluoride resins, polytrifluoroethylene resins, polyhexafluoropropylene resins, vinylidenefluoride-acrylate copolymers, vinylidenefluoride-vinylfluoride copolymers, copolymers of tetrafluoroethylene, vinylidenefluoride and other monomers including no fluorine atom, and silicone resins. An electroconductive powder may optionally be included in the toner. Specific examples of such electroconductive powders include metal powders, carbon blacks, titanium oxide, tin oxide, and zinc oxide. The average particle diameter of such electroconductive powders is preferably not greater than 1 μm. When the particle diameter is too large, it is hard to control the resistance of the resultant toner.

The toner of the present invention can also be used as a one-component magnetic developer or a one-component non-magnetic developer.

The toner of the present invention may include a magnetic material and can be used as a magnetic toner. Magnetic fine particles are included in the toner particles to prepare a magnetic toner. The specific examples of the magnetic materials include ferromagnetic metals or metal alloys such as irons such as ferrite and magnetite, nickel and cobalt or compounds including these elements; metal alloys without ferromagnetic elements, which become ferromagnetic when properly heated and are named Heusler alloys including manganese and copper such as manganese-copper-aluminium and manganese-copper tin; chromium dioxide, etc. It is preferable that the magnetic material is uniformly dispersed and included as a fine powder having an average particle diameter of from 0.1 to 1 μm. The toner preferably includes the magnetic material in an amount of from 10 to 70 parts by weight, and more preferably from 20 to 50 parts by weight.

The toner preferably includes a wax to improve the releasability thereof. Suitable waxes for use in the toner include waxes having a melting point of from 40 to 120° C. and preferably from 50 to 110° C. When the melting point of the wax included in the toner is too high, the low temperature fixability of the resultant toner deteriorates. To the contrary, when the melting point is too low, the offset resistance and durability of the resultant toner deteriorate. The melting point of waxes can be determined by a method using a differential scanning calorimeter. Namely, a few milligrams of a sample is heated at a constant heating speed (for example, 10° C./min) to determine the temperature at which the sample begins to melt. The toner preferably includes the wax in an amount of from 0 to 20 parts by weight, and more preferably from 0 to 10 parts by weight.

Specific examples of the waxes include solid paraffin waxes, microcrystalline waxes, rice waxes, fatty acid amide waxes, fatty acid waxes, aliphatic monoketones, fatty acid metal salt waxes, fatty acid ester waxes, partially-saponified fatty acid ester waxes, silicone varnishes, higher alcohols, carnauba waxes, polyolefins such as low molecular weight polyethylene and polypropylene, and the like waxes. In particular, polyolefins and esters preferably have a softening point of from 60 to 150° C., and more preferably from 70 to 120° C., which is determined by a ring and ball method.

Further, a wax selected from the group consisting of free-fatty-acid type carnauba waxes and montan ester waxes having an acid value not greater than 5, and oxidized rice waxes and Sasol Waxes having an acid value of from 10 to 30 is effectively used. The free-fatty-acid type carnauba wax is a carnauba wax from which a free fatty acid is freed, which has an acid value not greater than 5 and more microcrystalline form than conventional carnauba waxes, having a particle diameter not greater than 1 μm when dispersed in a toner binder to improve the dispersibility. The montan ester wax is typically a wax refined from a mineral substance, which has a microcrystalline form as the carnauba wax, having a particle diameter not greater than 1 μm when dispersed in a toner binder to improve the dispersibility. The montan ester wax preferably has an acid value of from 5 to 14.

The wax preferably has a particle diameter not greater than 3 μm, more preferably not greater than 2 μm, and even more preferably not greater than 1 μm when dispersed. When greater than 3 μm, the wax flowability and a transfer material separativeness improve, but the resultant toner deteriorates in high temperature and high humidity resistance, and charge stability.

The oxidized rice wax is a rice wax oxidized with air, preferably having an acid value of from 10 to 30. When less than 10, the minimum fixable temperature of the resultant toner rises, and which has insufficient low-temperature fixability. When greater than 30, the cold offset temperature of the resultant toner rises, and which has insufficient low-temperature fixability. Sasol Waxes include Sasol Waxes H1, H2, A1, A2, A3, A4, A6, A7, A14, C1, C2, SPRAY30, SPARY40, etc. from Sasol Wax GmbH. Particularly, H1, H2, SPRAY30 and SPARY40 are preferably used because the resultant toner has good low-temperature fixability and storage stability.

These waxes may be used alone or in combination, and are preferably included in a toner in an amount of from 1 to 15 parts, and more preferably from 2 to 10 parts by weight per 100 parts by weight of a binder resin.

A cleanability improver is preferably included in the toner or developer or added to a surface thereof to remove the toner or developer remaining on a photoreceptor and a first transfer medium after transfer. Specific examples of the cleanability improvers include fatty acid metal salts such as zinc stearate, sodium stearate and stearic acids; and polymer fine particles formed by a soap-free emulsifying polymerization method, such as polymethylmethacrylate fine particles and polystyrene fine particles. The polymer fine particles preferably has a comparatively narrow particle diameter distribution and a volume-average particle diameter of from 0.01 to 1 μm. The content of the cleanability improver is preferably from 0.001 to 5 parts by weight, and more preferably from 0.001 to 1 parts by weight per 100 parts by weight of a binder resin.

A method of producing the toner of the present invention includes a mixing process, a kneading process upon application of heat, a pulverizing process and a classifying process of a developer including a binder resin, a charge controlling agent and a colorant. In addition, the methods include a method of recycling a powder besides particles to be used for a toner in a pulverizing or a classifying process into a mechanical mixing process or a kneading process upon application of heat. The powder besides particles to be used for a toner (by-product) means fine particles and coarse particles besides toner particles having a desired particle diameter in the pulverizing process or the following classifying process. When such a by-product is mixed or kneaded upon application of heat with original materials, the by-product is preferably has a content of 1 part by weight or 50 parts by weight based on total weight of the toner materials.

A conventional mixer having a rotating blade can be used in the mechanical mixing process of a developer including at least a binder resin, a charge controlling agent, a colorant and the by-product in conventional conditions without any particular conditions.

After the mixing process, the mixture is kneaded upon application of heat in a kneader. A uniaxial or biaxial continuous kneader and a batch type kneader with a roll mill can be used. Specific examples of the marketed kneaders include TWIN SCREW EXTRUDER KTK (from Kobe Steel, Ltd.), TWIN SCREW COMPOUNDER TEM (from Toshiba Machine Co., Ltd.), MIRACLE K.C.K (from Asada Iron Works Co., Ltd.), TWIN SCREW EXTRUDER PCM (from Ikegai Co., Ltd), KOKNEADER (from Buss Corporation), etc.

It is important that the kneading process is performed in proper conditions so as not to cut a molecular chain of the binder resin. Specifically, a temperature of the kneading process upon application of heat is determined in consideration of a softening point of the binder resin. When the temperature is lower than the softening point, the molecular chain of the binder resin is considerably cut. When higher than the softening point, the dispersion does not proceed well. When controlling a volatile component in a toner, the temperature, time and atmosphere of the kneading process upon application of heat are preferably set most suitably while monitoring the real-time residual volatile component.

After the kneading process upon application of heat, the mixture is pulverized. In this pulverizing process, the mixture is preferably crashed, and then pulverized. The mixture is preferably pulverized by being crashed to a collision board in a jet stream, and pulverized by being passed through a narrow gap between a mechanically rotating rotor and a stator.

After the pulverizing process, the pulverized material is classified by a centrifugal force, etc. in a stream of air to prepare a toner having a predetermined particle diameter, e.g., weight-average particle diameter of from 2 to 7 μm. The weight-average particle diameter can be measured by a Coulter counter TA-II from Coulter Electronics, Inc., etc.

In addition, the above-mentioned oxidized particulate materials of the present invention and inorganic particulate materials les such as hydrophobic silica fine powders can be added to the thus prepared toner to increase the fluidity, storageability, developability and transferability thereof. A conventional powder mixer can be used to mix the external additive, and is preferably equipped with a jacket to control an inside temperature. In order to change a load to the external additive, the external additive may be added on the way of mixing process or gradually added to the toner. As a matter of course, the number of revolutions, a rolling speed, a time of mixing and a temperature of the mixer may be changed. A large load at the beginning and a small load later may be applied to the additive, and vice versa.

Specific examples of the mixers include a V-type mixer, a locking mixer, a Loedige Mixer, a Nauta Mixer, a Henschel Mixer, etc.

Besides, the following polymerization methods, capsule methods, etc. can prepare the toner of the present invention.

### [Polymerization Method 1]

(1) Granulating polymerizable monomers with a dispersant, and a polymerization initiator, a colorant, a wax, etc. when needed in an aqueous dispersion medium.

(2) Classifying the granulated monomer particulate composition.

(3) Polymerizing the classified monomer particulate composition.

(4) Removing the dispersant, washing and drying the polymerized product.

### [Polymerization Method 2]

Crosslinking and/or elongating toner constituents including at least a compound having an active hydrogen group, a polymer having a site reactable with the active hydrogen group, a polyester resin, a colorant and a release agent in an aqueous medium under the presence of a particulate resin.

(i) A colorant, an unmodified polyester, a polyester prepolymer having an isocyanate group (A) and a release agent are dispersed in an organic solvent to prepare a toner constituent liquid.

The organic solvent is preferably a volatile solvent having a boiling point less than 100° C. because of being easily removed after a toner particle is formed. Specific examples of the organic solvents include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, methyl ethyl ketone and methylisobutyl ketone. These can be used alone or in combination. Particularly, aromatic solvents such as the toluene and xylene and halogenated hydrocarbons such as the methylene chloride, 1,2-dichloroethane, chloroform and carbon tetrachloride. A content of the organic solvent is typically from 0 to 300 parts by weight, preferably from 0 to 100 parts by weight, and more preferably from 25 to 70 parts by weight per 100 parts by weight of the polyester prepolymer.

(ii) The toner constituent liquid is emulsified in an aqueous medium in the presence of a surfactant and a particulate resin.

The aqueous medium may include water alone and mixtures of water with a solvent which can be mixed with water. Specific examples of the solvent include alcohols such as methanol, isopropanol and ethylene glycol; dimethylformamide; tetrahydrofuran; cellosolves such as methyl cellosolve; and lower ketones such as acetone and methyl ethyl ketone.

The content of the water medium is typically from 50 to 2,000 parts by weight, and preferably from 100 to 1,000 parts by weight per 100 parts by weight of the toner constituent liquid. When the content is less than 50 parts by weight, the toner constituent liquid is not well dispersed and a toner particle having a predetermined particle diameter cannot be formed. When the content is greater than 20,000 parts by weight, the production cost increases.

A dispersant such as a surfactant and particulate resin is optionally included in the aqueous medium to improve the dispersion therein.

Specific examples of the surfactants include anionic surfactants such as alkylbenzene sulfonic acid salts, α-olefin sulfonic acid salts, and phosphoric acid salts; cationic surfactants such as amine salts (e.g., alkyl amine salts, aminoalcohol fatty acid derivatives, polyamine fatty acid derivatives and imidazoline), and quaternary ammonium salts (e.g., alkyltrimethyl ammonium salts, dialkyldimethyl ammonium salts, alkyldimethyl benzyl ammonium salts, pyridinium salts, alkylisoquinolinium salts and benzethonium chloride); nonionic surfactants such as fatty acid amide derivatives, polyhydric alcohol derivatives; and ampholytic surfactants such as alanine, dodecyldi(aminoethyl)glycin, di(octylaminoethyle)glycin, and N-alkyl-N,N-dimethylammonium betaine.

A surfactant having a fluoroalkyl group can prepare a dispersion having good dispersibility even when a small amount of the surfactant is used.

Specific examples of anionic surfactants having a fluoroalkyl group include fluoroalkyl carboxylic acids having from 2 to 10 carbon atoms and their metal salts, disodium perfluorooctanesulfonylglutamate, sodium 3-{omega-fluoroalkyl(C6-C11)oxy}-1-alkyl(C3-C4) sulfonate, sodium-{omega-fluoroalkanoyl(C6-C8)-N-ethylamino}-1-propane sulfonate, fluoroalkyl(C11-C20) carboxylic acids and their metal salts, perfluoroalkylcarboxylic acids and their metal salts, perfluoroalkyl (C4-C12) sulfonate and their metal salts, perfluorooctanesulfonic acid diethanol amides, N-propyl-N-(2-hydroxyethyl)perfluorooctanesulfone amide, perfluoroalkyl(C6-C10)sulfoneamidepropyltrimethylammonium salts,salts of perfluoroalkyl (C6-C10) -N-ethylsulfonylglycin, monoperfluoroalkyl(C6-C16)ethylphosphates, etc.

Specific examples of the marketed products of such surfactants having a fluoroalkyl group include SURFLON S-111, S-112 and S-113, which are manufactured by Asahi Glass Co., Ltd.; FRORARD FC-93, FC-95, FC-98 and FC-129, which are manufactured by Sumitomo 3M Ltd.; UNIDYNE DS-101 and DS-102, which are manufactured by Daikin Industries, Ltd.; MEGAFACE F-110, F-120, F-113, F-191, F-812 and F-833 which are manufactured by Dainippon Ink and Chemicals, Inc.; ECTOPEF-102, 103, 104, 105, 112, 123A, 306A, 501, 201 and 204, which are manufactured by Tohchem Products Co., Ltd.; FUTARGENT F-100 and F150 manufactured by Neos; etc.

Specific examples of the cationic surfactants, which can disperse an oil phase including toner constituents in water, include primary, secondary and tertiary aliphatic amines having a fluoroalkyl group, aliphatic quaternary ammonium salts such as erfluoroalkyl(C6-C10)sulfoneamidepropyltrimethylammonium salts, benzalkonium salts, benzetonium chloride, pyridinium salts, imidazolinium salts, etc. Specific examples of the marketed products thereof include SURFLONS-121 (from Asahi Glass Co., Ltd.); FRORARD FC-135 (from Sumitomo 3M Ltd.); UNIDYNE DS-202 (from Daikin Industries, Ltd.); MEGAFACE F-150 and F-824 (from Dainippon Ink and Chemicals, Inc.); ECTOP EF-132 (from Tohchem Products Co., Ltd.); FUTARGENT F-300 (from Neos); etc.

The particulate resin is included to stabilize a toner particle formed in the aqueous medium. Therefore, the particulate resin is preferably included so as to have a coverage of from 10 to 90% over a surface of the toner particle. Specific examples of the particulate resins include polymethylmethacrylate fine particles having particle diameters of 1 μm and 3 μm, polystyrene fine particles having particle diameters of 0.5 μm and 2 μm and a polystyrene-acrylonitrile fine particle having a particle diameter of 1 μm. These are marketed as PB-200 from Kao Corporation, SGP from Soken Chemical & Engineering Co., Ltd., Technopolymer SB from Sekisui Plastics Co., Ltd., SGP-3G from Soken Chemical & Engineering Co., Ltd. and Micro Pearl from Sekisui Chemical Co., Ltd.

In addition, inorganic dispersants such as tricalcium phosphate, calcium carbonate, titanium oxide, colloidal silica and hydroxy apatite can also be used.

As dispersants which can be used in combination with the above-mentioned particulate resin and inorganic dispersants, it is possible to stably disperse toner constituents in water using a polymeric protection colloid. Specific examples of such protection colloids include polymers and copolymers prepared using monomers such as acids (e.g., acrylic acid, methacrylic acid, α-cyanoacrylic acid, α-cyanomethacrylic acid, itaconic acid, crotonic acid, fumaric acid, maleic acid and maleic anhydride), acrylic monomers having a hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide and N-methylolmethacrylamide), vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g, acrylamide, methacrylamide and diacetoneacrylamide) and their methylol compounds, acid chlorides (e.g., acrylic acid chloride and methacrylic acid chloride), and monomers having a nitrogen atom or an alicyclic ring having a nitrogen atom (e.g., vinyl pyridine, vinyl pyrrolidone, vinyl imidazole and ethylene imine). In addition, polymers such as polyoxyethylene compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters); and cellulose compounds such as methyl cellulose, hydroxyethyl cellulose and hydroxypropyl cellulose, can also be used as the polymeric protective colloid.

The dispersion method is not particularly limited, and low speed shearing methods, high-speed shearing methods, friction methods, high-pressure jet methods, ultrasonic methods, etc. can be used. Among these methods, high-speed shearing methods are preferably used because particles having a particle diameter of from 2 to 20 μm can be easily prepared. At this point, the particle diameter (2 to 20 μm) means a particle diameter of particles including a liquid). When a high-speed shearing type dispersion machine is used, the rotation speed is not particularly limited, but the rotation speed is typically from 1,000 to 30,000 rpm, and preferably from 5,000 to 20,000 rpm. The dispersion time is not also particularly limited, but is typically from 0.1 to 5 minutes. The temperature in the dispersion process is typically from 0 to 150° C. (under pressure) and preferably from 40 to 98° C.

iii) While an emulsion is prepared, amines (B) are included therein to be reacted with the polyester prepolymer (A) having an isocyanate group to prepare a urea-modified polyester resin.

The polyester prepolymer (A) having an isocyanate group is formed from a reaction between the polyester resin having an active hydrogen group formed by polycondensation between polyol (PO) and a polycarboxylic acid (PC), and a polyisocyanate compound (PIC).

Specific examples of the amines (B) to be reacted with the polyester prepolymer (A) include diamines (B1), polyamines (B2) having three or more amino groups, amino alcohols (B3), amino mercaptans (B4), amino acids (B5) and blocked amines (B6) in which the amines (B1-B5) mentioned above are blocked.

Specific examples of the diamines (B1) include aromatic diamines (e.g., phenylene diamine, diethyltoluene diamine and 4,4′-diaminodiphenyl methane); alicyclic diamines (e.g., 4,4′-diamino-3,3′-dimethyldicyclohexyl methane, diaminocyclohexane and isophoronediamine); aliphatic diamines (e.g., ethylene diamine, tetramethylene diamine and hexamethylene diamine); etc. Specific examples of the polyamines (B2) having three or more amino groups include diethylene triamine, triethylene tetramine. Specific examples of the amino alcohols (B3) include ethanol amine and hydroxyethyl aniline. Specific examples of the amino mercaptan (B4) include aminoethyl mercaptan and aminopropyl mercaptan. Specific examples of the amino acids (B5) include amino propionic acid and amino caproic acid. Specific examples of the blocked amines (B6) include ketimine compounds which are prepared by reacting one of the amines B1-B5 mentioned above with a ketone such as acetone, methyl ethyl ketone and methyl isobutyl ketone; oxazolinecompounds, etc. Among these amines (B), diamines (B1) and mixtures in which a diamine is mixed with a small amount of a polyamine (B2) are preferably used.

A mixing ratio (i.e., a ratio [NCO]/[NHx]) of the content of the prepolymer (A) having an isocyanate group to the amine (B) is from 1/2 to 2/1, preferably from 1.5/1 to 1/1.5 and more preferably from 1.2/1 to 1/1.2. When the mixing ratio is greater than 2 or less than 1/2, molecular weight of the urea-modified polyester decreases, resulting in deterioration of hot offset resistance of the resultant toner.

This reaction is accompanied by a crosslinking and/or a elongation of a molecular chain. The reaction time depends on reactivity of an isocyanate structure of the prepolymer (A) and amines (B), but is typically from 10 min to 40 hrs, and preferably from 2 to 24 hrs. The reaction temperature is typically from 0 to 150° C., and preferably from 40 to 98° C. In addition, a known catalyst such as dibutyltinlaurate and dioctyltinlaurate can be used.

(iv) After the reaction is terminated, an organic solvent is removed from an emulsified dispersion (a reactant), which is washed and dried to form a toner mother particle.

The prepared emulsified dispersion (reactant) is gradually heated while stirred in a laminar flow, and an organic solvent is removed from the dispersion after stirred strongly when the dispersion has a specific temperature to from a toner particle having a shape of spindle. When an acid such as calcium phosphate or a material soluble in alkaline is used as a dispersant, the calcium phosphate is dissolved with an acid such as a hydrochloric acid and washed with water to remove the calcium phosphate from the toner particle. Besides this method, it can also be removed by an enzymatic hydrolysis.

(v) A charge controlling agent is beat in the toner particle, and inorganic fine particles such as silica fine particles and titanium oxide fine particles are externally added thereto to form a toner.

Known methods using a mixer, etc. are used to beat in the charge controlling agent and to externally add the inorganic fine particles.

Thus, a toner having a small particle diameter and a sharp particle diameter distribution can be obtained. Further, the strong agitation in the process of removing the organic solvent can control the shape of a toner from a sphere to a rugby ball, and the surface morphology thereof from being smooth to a pickled plum.

### [Polymerization Method 3]

(1) Dispersing a low-molecular-weight resin, a polymeric resin, a colorant, a wax, a wax dispersant, and a charge controlling agent, etc. when needed in an oil layer dispersion medium including a solvents such as ethylacetate to prepare a dispersion.

(2) Dropping the dispersion in water including an organic particulate material and an elongator to prepare an emulsion.

(3) Heating, polymerizing and de-solventing the emulsion to form particles.

(4) Aging the particles in water, and washing, collecting and drying to form toner mother particles.

### [Capsule Method]

(1) Kneading a binder resin, and a colorant, etc. when needed with a kneader to prepare a toner core material.

(2) Strongly stirring the toner core material to form a particulate core material.

(3) Placing the particulate core material in a shell material solution, and dropping a poor solvent into the solution while stirring the solution to cover the core material with the shell material to form a capsule.

(4) Filtering and drying the capsule to prepare toner mother particles.

Next, the image forming apparatus of the present invention will be explained.

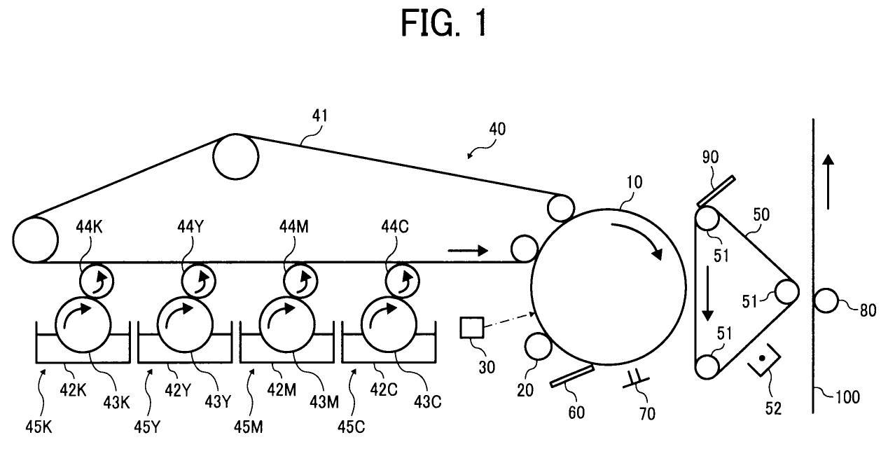

FIG. 1 is a schematic view illustrating an embodiment of the image forming apparatus of the present invention.

Around a photoreceptor drum (hereinafter referred to as a photoreceptor) as an image bearer 10, a charging roller as a charger 20, an irradiator 30, a cleaner having a cleaning blade 60, a discharge lamp as a discharger 70, an image developer 40 and a intermediate transferer 50 are arranged. The intermediate transferee 50 is suspended by plural suspension rollers 51 and endlessly driven by a driver such as motor (not shown) in a direction indicated by an arrow. Some of the suspension rollers 51 are combined with roles of transfer bias rollers feeding a transfer bias to the intermediate transferer and a predetermined transfer bias is applied thereto from an electric source (not shown). A cleaner having a cleaning blade 90 cleaning the intermediate transferer 50 is also arranged. A transfer roller 80 transferring a toner image onto a transfer paper 100 as a final transferer is arranged facing the intermediate transferer 50, to which a transfer bias is applied from an electric source (not shown). Around the intermediate transferer 50, a corona charger 52 is arranged as a charger.

The image developer 40 includes a developing belt 41 as a developer bearer, a black (Bk) developing unit 45K, a yellow (Y) developing unit 45Y, a magenta (M) developing unit 45M and a cyan (C) developing unit 45C around the developing belt 41. The developing belt 41 is extended over plural belt rollers, endlessly driven by a driver such as motor (not shown) in a direction indicated by an arrow and driven at almost a same speed as the photoreceptor 10 at a contact point therewith.

Since each developing unit has a same configuration, only Bk developing unit 50Bk will be explained, and explanations of other developing units 50Y, 50M and 50C are omitted. The developing unit 50Bk includes a developer tank 42Bk including a high-viscosity and high-concentration liquid developer including a toner and a carrier liquid, a scoop roller 43Bk with a bottom dipped in the liquid developer in the developer tank 42Bk and an application roller 44Bk applying a thin layer of the developer scooped by the scoop roller 43Bk to the developing belt 41. The application roller 44Bk has an electroconductivity and a predetermined bias is applied thereto from an electric source (not shown).

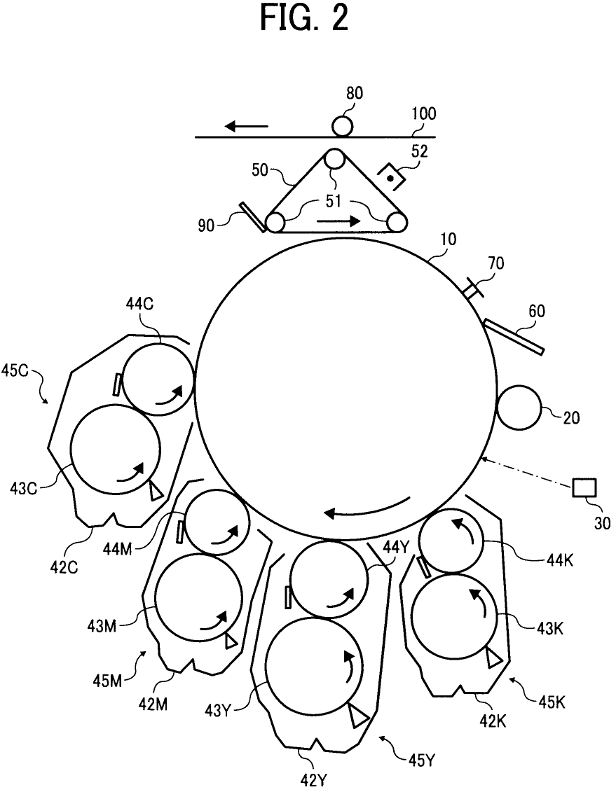

In the present invention, besides the embodiment of a full-color copier in FIG. 1, an embodiment of a full-color copier in FIG. 2 wherein developing units for each color are located around a photoreceptor can be used.

In FIG. 1, after the photoreceptor 10 is uniformly charged rotating in a direction indicated by an arrow, the irradiator 30 irradiates the photoreceptor 10 with an original imagewise light from an optical system (not shown) to form an electrostatic latent image thereon. The electrostatic latent image is developed by the image developer 40 to form a visual toner image thereon. The developer thin layer on the developing belt 41 is released therefrom as it is and transferred onto a part the electrostatic latent image is formed on. The toner image developed by the image developer 40 is transferred onto the surface of the intermediate transferer 50 (first transfer) driven at a same speed as that of the photoreceptor 10 at a contact point (first transfer area) therewith. When 3 or 4 colors are overlaid on the intermediate transferer 50 to form a full-color image thereon.

In the rotating direction of the intermediate transferee 50, the corona charger 52 charging the toner image thereon is located in a downstream of the contact point between the photoreceptor 10 and the intermediate transferer 50, and in an upstream of a contact point between the intermediate transferer 50 and the transfer paper 100. The corona charger 52 applies a sufficient charge having a same polarity as that of the toner particle to the toner image so as to be transferred well onto the transfer paper 100. After the toner image is charged by the corona charger 52, the toner image is transferred at a time by a transfer bias from the transfer roller 80 onto the transfer paper 100 fed from a paper feeder (not shown) in a direction indicated by an arrow. Then, the transfer paper 100 the toner image is transferred onto is separated from the photoreceptor 10 by a separator (not shown). After the toner image is fixed thereon by a fixer (not shown), the transfer paper 100 is discharged from the copier. On the other hand, untransferred toner is removed from the photoreceptor 10 by a cleaner 60 after the toner image is transferred, and discharged by the discharge lamp 70 to be ready for the following charge. A full-color image is typically formed of 4 colored toners. The full-color image includes 1 to 4 toner layers. The toner layer passes a first transfer (transfer from a photoreceptor to an intermediate transfer belt) and a second transfer (from the intermediate transfer belt to a sheet).

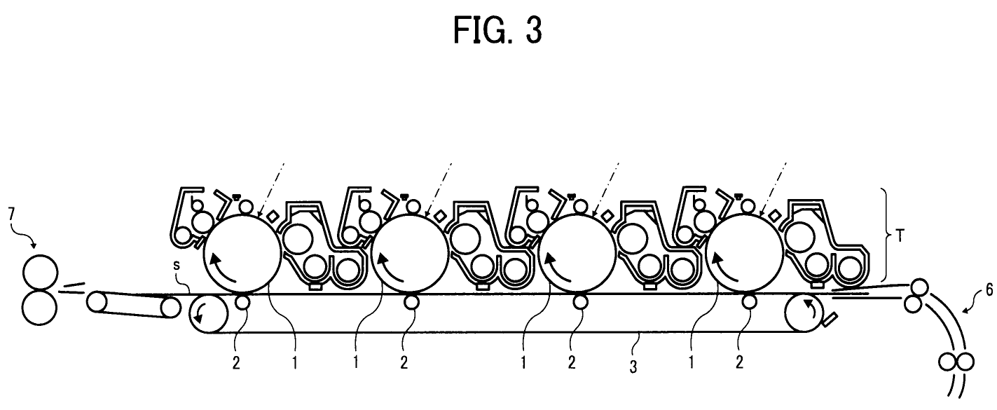

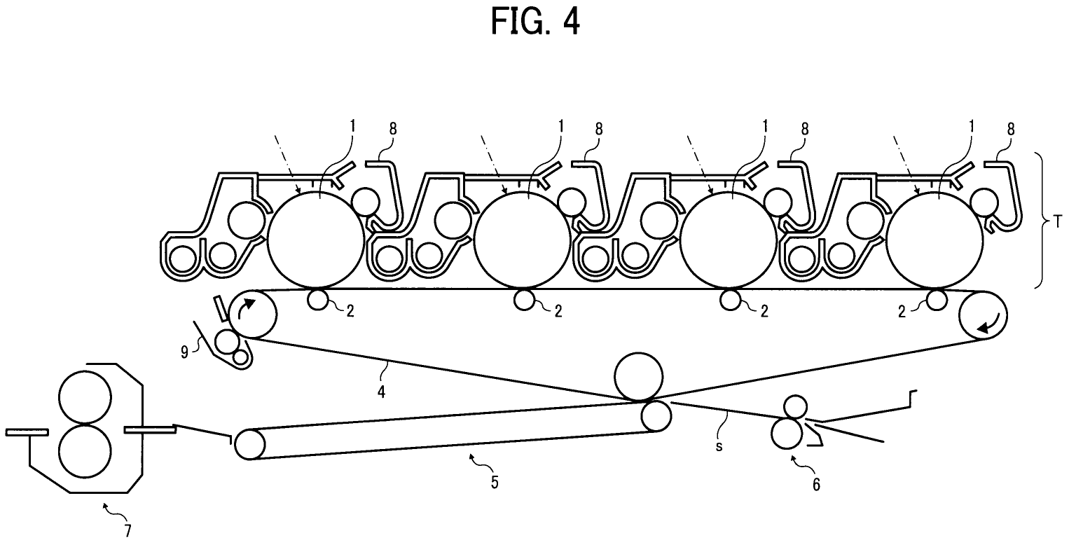

FIG. 3 is a schematic view illustrating a further embodiment of the image forming apparatus of the present invention, i.e., a tandem type full-color image forming apparatus. The tandem type full-color image forming apparatus includes an apparatus using a direct transfer method of sequentially transferring an image on each photoreceptor 1 with a transferer 2 onto a sheet s fed by a sheet feeding belt 3 as shown in FIG. 3, and an apparatus using an indirect transfer method of sequentially transferring an image on each photoreceptor 1 with a first transferer 2 onto an intermediate transferer 4 and transferring the image thereon onto a sheet s with a second transferer 5 as shown in FIG. 4. The second transferee 5 has the shape of a belt, and may have the shape of a roller.

The direct transfer method has a disadvantage of being large toward a sheet feeding direction because a paper feeder 6 is located in an upstream of a tandem-type image forming apparatus T having photoreceptors 1 in line, and a fixer 7 in a downstream thereof. To the contrary, the indirect method can be downsized because of being able to freely locate the second transferer, and can locate a paper feeder 6 and a fixer 7 together with a tandem-type image forming apparatus T.

To avoid being large toward a sheet feeding direction, the former method locates the fixer 7 close to the tandem-type image forming apparatus T. Therefore, the sheet s cannot flexibly enter the fixer 7, and an impact thereof to the fixer 7 when entering the fixer 7 and a difference of feeding speed of the sheet s between when passing through the fixer 7 and when fed by a feeding belt tend to affect an image formation in the upstream.

To the contrary, the latter method can flexibly locate the fixer 7, and therefore the fixer 7 scarcely affects the image formation.

Therefore, recently, the tandem-type electrophotographic image forming apparatus using an indirect transfer method is widely used.

In this type of full-color electrophotographic image forming apparatus, as shown in FIG. 4, a photoreceptor cleaner 8 removes a residual toner on a photoreceptor 1 to clean the surface thereof after a first transfer and ready for another image formation. In addition, an intermediate transferer cleaner 9 removes a residual toner on an intermediate transferer 4 to clean the surface thereof after second transfer and ready for another image formation.

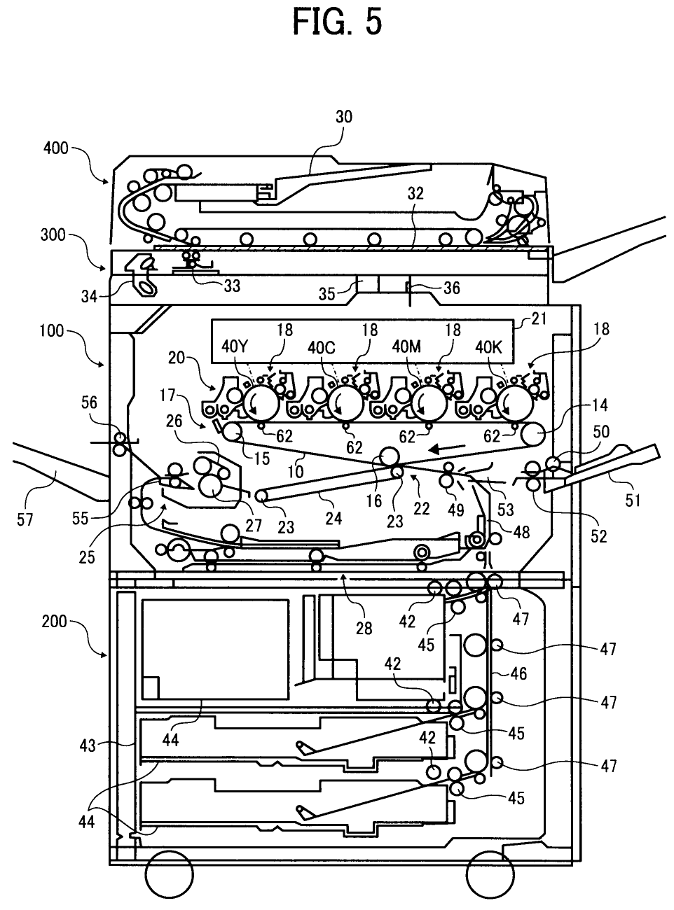

FIG. 5 is a schematic view illustrating a further embodiment of the image forming apparatus of the present invention, i.e., a tandem type electrophotographic image forming apparatus using an indirect transfer method. Numeral 100 is a copier, 200 is a paper feeding table, 300 is a scanner on the copier 100 and 400 is an automatic document feeder (ADF) on the scanner 300. The copier 100 includes an intermediate transferer 10 having the shape of an endless belt.

As shown in FIG. 5, the intermediate transferer 10 is suspended by three suspension rollers 14, 15 and 16 and rotatable in a clockwise direction.

On the left of the suspension roller 15, an intermediate transferer cleaner 17 is located to remove a residual toner on an intermediate transferer 10 after an image is transferred.

Above the intermediate transferer 10, four image forming units 18 for yellow, cyan, magenta and black colors are located in line from left to right along a transport direction of the intermediate transferer 10 to form a tandem image forming apparatus 20.

Above the tandem image forming apparatus 20, an irradiator 21 is located as shown in FIG. 5. On the opposite side of the tandem image forming apparatus 20 across the intermediate transferer 10, a second transferer 22 is located. The second transferer 22 includes a an endless second transfer belt 24 and two rollers 23 suspending the endless second transfer belt 24, and is pressed against the suspension roller 16 across the intermediate transferer 10 and transfers an image thereon onto a sheet.

Beside the second transferer 22, a fixer 25 fixing a transferred image on the sheet is located. The fixer 25 includes an endless belt 26 and a pressure roller 27 pressed against the belt.

The second transferee 22 also includes a function of transporting the sheet an image is transferred on to the fixer 25. As the second transferer 22, a transfer roller and a non-contact charger may be used. However, they are difficult have such a function of transporting the sheet.

In FIG. 5, below the second transferer 22 and the fixer 25, a sheet reverser 28 reversing the sheet to form an image on both sides thereof is located in parallel with the tandem image forming apparatus 20.

An original is set on a table 30 of the ADF 400 to make a copy, or on a contact glass 32 of the scanner 300 and pressed with the ADF 400. When a start switch (not shown) is put on, a first scanner 33 and a second scanner 34 scans the original after the original set on the table 30 of the ADF 400 is fed onto the contact glass 32 of the scanner 300, or immediately when the original set thereon. The first scanner 33 emits light to the original and reflects reflected light therefrom to the second scanner 34. The second scanner further reflects the reflected light to a reading sensor 36 through an imaging lens 35 to read the original.

When a start switch (not shown) is put on, a drive motor (not shown) rotates one of the suspension rollers 14, 15 and 16 such that the other two rollers are driven to rotate, to rotate the intermediate transferer 10. At the same time, each of the image forming units 18 rotates the photoreceptor 40 and forms a single-colored image, i.e., a black image, a yellow image, a magenta image and cyan image on each photoreceptor 40. The single-colored images are sequentially transferred onto the intermediate transferee 10 to form a synthesized color image thereon.

On the other hand, when start switch (not shown) is put on, one of paper feeding rollers 42 of paper feeding table 200 is selectively rotated to take a sheet out of one of multiple-stage paper cassettes 44 in a paper bank 43. A separation roller 45 separates sheets one by one and feed the sheet into a paper feeding route 46, and a feeding roller 47 feeds the sheet into a paper feeding route 48 of the copier 100 to be stopped against a registration roller 49. Alternatively, a paper feeding roller 50 is rotated to take a sheet out of a manual feeding tray 51, and a separation roller 52 separates sheets one by one and feed the sheet into a paper feeding route 53 to be stopped against a registration roller 49.

Then, in timing with a synthesized full-color image on the intermediate transferer 10, the registration roller 49 is rotated to feed the sheet between the intermediate transferer 10 and the second transferer 22, and the second transferer transfers the full-color image onto the sheet.

The sheet the full-color image is transferred thereon is fed by the second transferer 22 to the fixer 25. The fixer 25 fixes the image thereon upon application of heat and pressure, and the sheet is discharged by a discharge roller 56 onto a catch tray 57 through a switch-over click 55. Alternatively, the switch-over click 55 feeds the sheet into the sheet reverser 28 reversing the sheet to a transfer position again to form an image on the back side of the sheet, and then the sheet is discharged by the discharge roller 56 onto the catch tray 57.

On the other hand, the intermediate transferee 10 after transferring an image is cleaned by the intermediate transferer cleaner 17 to remove a residual toner thereon after the image is transferred, and ready for another image formation by the tandem image forming apparatus 20.

The registration roller 49 is typically earthed, and a bias may be applied thereto remove paper dust from the sheet.

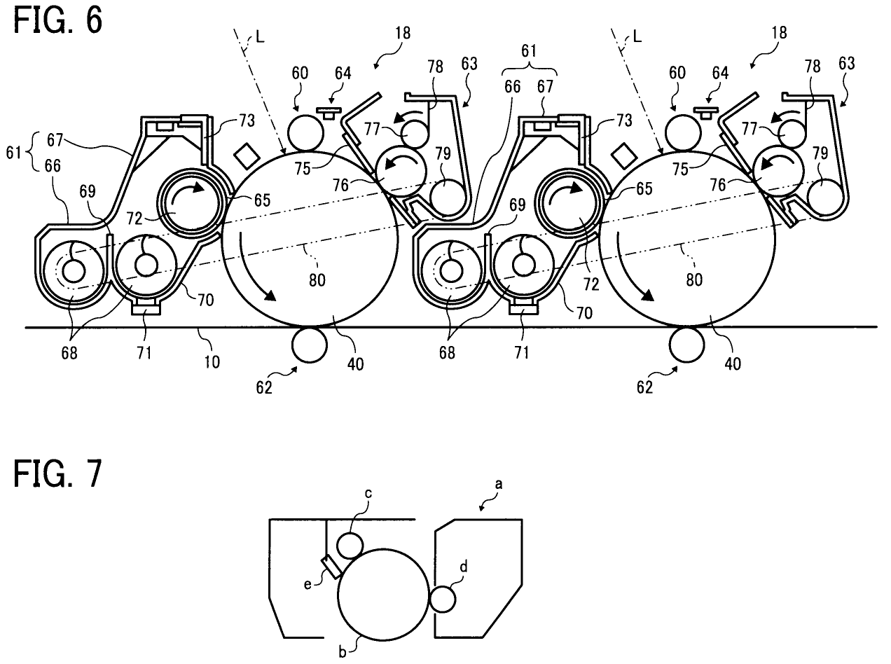

In the tandem image forming apparatus 20, each of the image forming units 18 includes, as shown in FIG. 6, a charger 60, an image developer 61, a first transferer 62, a photoreceptor cleaner 63 and a discharger 64 around a drum-shaped photoreceptor 10. Numeral 65 represents a developer present on a developing sleeve 72, 68 represents an agitation paddle, 69 represents a division plate, 71 represents a toner concentration sensor, 73 represents a doctor blade, 75 represents a cleaning blade, 76 represents a cleaning brush, 77 represents a cleaning roller, 78 represents a cleaning blade, 79 represents a toner discharging auger, and 80 represents a drive device.

FIG. 7 is a schematic view illustrating a process cartridge of the present invention, wherein (a) is a whole process cartridge, (b) is a photoreceptor, (c) is a charger, (d) is an image developer and (e) is a cleaner.

In the present invention, at least (b) and (d) are combined in a body as a process cartridge detachable from an image forming apparatus such as a copier and a printer.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

A partially-modified tandem type full-color copier imagio MP C4500 having non-magnetic two-component image developers for 4-colors and photoreceptors for 4-colors from Ricoh Company, Ltd. was used to print at a high speed (40 pieces of A4/min) with the toners (developers) prepared in Examples and Comparative Examples to evaluate them.

### (Evaluated Items)

### (1) External Additive Burial

After the developer was stored in an environment at 40° C. and 80% Rh for one week, the surface of the toner was observed to see how the external additive was buried in the toner with a FE-SEM (field emission scanning electron microscope Ulttra55 from Carl Zeiss, Inc.) after stirred in the image developer for 1 hr. x represents that the original external additives are almost completely buried; □ represents that some of the external additives are completely buried; ∘ represents that some of the external additives are partially buried; and □ represents that the external additives are scarcely buried or moved.

### (2) Cleanability in Low-Temperature and Low-Humidity Environment

The toner remaining after transferred on the photoreceptor having passed the cleaning process after 50,000 images of an image density chart having an image area of 5% were produced in an environment at 10° C. and 15% Rh was taped with SCOTCH TAPE from Sumitomo 3M Ltd. and transferred onto a white paper. The image density thereof was measured by X-Rite 938 from X-Rite, Inc. When a difference of the density between the white paper the residual toner was transferred onto and a blank space thereof was less than 0.005, the transferability was determined as □. From 0.005 to less than 0.010 was ∘, from 0.010 to less than 0.02 was □, and not less than 0.02 was x.

### (3) Toner Feedability

Each 4,000 images of an image chart having an image area of 90% and that having an image area of 5% were alternately produced to see the toner feedability. x represents that the toner could not be fed at all; □ represents that the toner feeding was blocked as time passed; ∘ represents that the toner feeding was not blocked, but some images had uneven image density due to toner feeding stagnation; and □ represents that the external additives are scarcely buried or moved.

### (4) Image Density Stability

After 500 images of a chart having an image area of 5% and further 300 images of a chart having an image area of 50% were produced while the image density process control was off, the image density of a following image was measured by X-Rite 938 from X-Rite, Inc. Image densities of three points equivalent to the Front, Center and Rear of the photoreceptor were measure, and an average thereof was compared with the initial image density. ∘ represents that the difference was from 0 to less than 0.1; □ represents that the difference was from 0.1 to less than 0.3; and x represents that the difference was not less than 0.3.

### (5) Filming Resistance

An attached content on the photoreceptor after 50,000 images of an image density chart having an image area of 5% were produced was visually observed. x represents that the photoreceptor had a large foggy area; x represents that the photoreceptor had a foggy stripe; □ represents that the photoreceptor had a slight foggy stripe; and □ represents that the photoreceptor had no foggy area.

### (6) Image Granularity and Sharpness

Mono-color images were produced and visually observed to evaluate the image granularity and sharpness. L was as good as an offset printing, ∘ was slightly worse than the offset printing, □ was considerably worse than the offset printing and x was very poor.

### (7) Heat-Resistant Storage Stability

10 g of the toner was put in a glass container having a capacity of 20 ml and the glass container was tapped for 100 times. Then, after the glass container was left in a constant temperature bath having a temperature of 55° C. for 24 hrs, a penetration of the toner was measured by a penetrometer. The larger the better. □ was not less than 20 mm, ∘ was not less than 15 mm and less than 20 mm, □ was not less than 10 mm and less than 15 mm and x was less than 10 mm.

### (8) Fixability

The fixer of a full-color multifunctional printer imagio NeoC600Pro was modified such that the temperature and linear speed were controllable. Solid images including a toner of 0.85±0.1 mg/cm² were produced thereby on transfer papers TYPE 6000<70W> and copy printing paper <135>. The fixable minimum temperature was a temperature of the fixing roller, at which a residual ratio of the image density after scraped with a pad was not less than 70%. The lower the better. □ was less than 120° C., ∘ was from 120° C. to less than 140° C., □ was from 140° C. to less than 160° C. and x was less than 160° C.

When evaluating images with a two-component developer, 100 parts of a ferrite carrier having an average particle diameter of 35 μm, coated with a silicone resin layer having an average thickness of 0.5 μm, and 7 parts of each color toner were uniformly mixed in a Turbular Mixer to form a two-component developer as follows.

The following coating materials were dispersed by a stirrer for 10 min to prepare a coating liquid.

| | |
|---|---|
| Toluene | 450 |
| Silicone resin | 450 |
| SR2400 having a nonvolatile matter of 50% from Dow Corning | |
| Toray Silicone Co., Ltd. | |
| Amino silane | 10 |
| SH6020 from Dow Corning Toray Silicone Co., Ltd. | |
| Carbon black | 10 |

The coating liquid was coated on the following core material by a coater coating while forming a spiral flow with a rotational bottom board disc and a stirring blade in a fluidizing bed.

| | |
|---|---|
| Cu—Zn Ferrite particle | 5,000 |
| having a weight-average particle diameter of 35 μm | |

The coated material was calcined in an electric oven at 250° C. for 2 hrs to prepare a carrier 1.

### (Oxidized Particulate Material 1)

In a 3-litter glass-made reaction vessel equipped with a stirrer, a dripping funnel and a thermometer, 624 g of methanol, 41 g of water and 50 g of 30%-concentration ammonia water were mixed to prepare a mixed solution. The mixed solution was heat to have a temperature of 28° C., and 1,143 g of tetramethoxysilane and 418 g of ammonia water having a concentration of 5.2% by weight were dripped therein at the same time for 8 hrs while stirred. Even after dripping, the mixed solution was stirred for 2 hrs and subjected to cohydrolysis and condensation reactions to prepare an oxidized particulate material (silica) dispersion. After 242 g of hexamethyldisilazane were added into the dispersion at room temperature, the dispersion was heated to have a temperature of 60° C. and subjected to a reaction for 6 hrs to trimethylsilylate the particulate silica. Then, the solvent was removed from the dispersion under reduced pressure to prepare an aggregate of fine powder. The aggregate of fine powder was pulverized by a jet mill and the fine powder was collected by a bug filter to prepare an oxidized particulate material 1.

### (Oxidized Particulate Material 2)

In a 3-litter glass-made reaction vessel equipped with a stirrer, a dripping funnel and a thermometer, 624 g of methanol, 41 g of water and 50 g of 30%-concentration ammonia water were mixed to prepare a mixed solution. The mixed solution was heat to have a temperature of 33° C., and 1,143 g of tetramethoxysilane and 418 g of ammonia water having a concentration of 5.2% by weight were dripped therein at the same time for 6 hrs while stirred. Even after dripping, the mixed solution was stirred for 2 hrs and subjected to cohydrolysis and condensation reactions to prepare an oxidized particulate material (silica) dispersion. After 242 g of hexamethyldisilazane were added into the dispersion at room temperature, the dispersion was heated to have a temperature of 60° C. and subjected to a reaction for 6 hrs to trimethylsilylate the particulate silica. Then, the solvent was removed from the dispersion under reduced pressure to prepare an aggregate of fine powder. The aggregate of fine powder was pulverized by a jet mill and the fine powder was collected by a bug filter to prepare an oxidized particulate material 2.

### (Oxidized Particulate Material 3)

In a 3-litter glass-made reaction vessel equipped with a stirrer, a dripping funnel and a thermometer, 624 g of methanol, 41 g of water and 50 g of 30%-concentration ammonia water were mixed to prepare a mixed solution. The mixed solution was heat to have a temperature of 22° C., and 1,143 g of tetramethoxysilane and 418 g of ammonia water having a concentration of 5.2% by weight were dripped therein at the same time for 2 hrs while stirred. Even after dripping, the mixed solution was stirred for 2 hrs and subjected to cohydrolysis and condensation reactions to prepare an oxidized particulate material (silica) dispersion. After 242 g of hexamethyldisilazane were added into the dispersion at room temperature, the dispersion was heated to have a temperature of 60° C. and subjected to a reaction for 6 hrs to trimethylsilylate the particulate silica. Then, the solvent was removed from the dispersion under reduced pressure to prepare an aggregate of fine powder. The aggregate of fine powder was pulverized by a jet mill and the fine powder was collected by a bug filter to prepare an oxidized particulate material 3.

### (Oxidized Particulate Material 4)

In a 3-litter glass-made reaction vessel equipped with a stirrer, a dripping funnel and a thermometer, 624 g of methanol, 41 g of water and 50 g of 30%-concentration ammonia water were mixed to prepare a mixed solution. The mixed solution was heat to have a temperature of 22° C., and 1,143 g of tetramethoxysilane and 418 g of ammonia water having a concentration of 5.2% by weight were dripped therein at the same time for 2 hrs while stirred. Even after dripping, the mixed solution was stirred for 2 hrs and subjected to cohydrolysis and condensation reactions to prepare an oxidized particulate material (silica) dispersion. After 242 g of hexamethyldisilazane were added into the dispersion at room temperature, the dispersion was heated to have a temperature of 60° C. and subjected to a reaction for 6 hrs to trimethylsilylate the particulate silica. Then, the solvent was removed from the dispersion under reduced pressure to prepare a particulate material. The particulate material and 50 g of polydimethylsiloxane having a viscosity of 300 cs were subjected to ultrasonic while stirred to be dispersed in 1,000 g of toluene to prepare a dispersion. After visually recognizing that there is no aggregate therein, the solvent was removed therefrom under reduced pressure to prepare a solid content. The solid content was dried under reduced pressure until having a constant mass at 50° C., and was heated at 100° C. for 2 hrs under a nitrogen stream in an electric oven to prepare an aggregate of fine powder. The aggregate of fine powder was pulverized by a jet mill and the fine powder was collected by a bug filter to prepare an oxidized particulate material 4.

### (Oxidized Particulate Material 5)

In a 3-litter glass-made reaction vessel equipped with a stirrer, a dripping funnel and a thermometer, 624 g of methanol, 41 g of water and 50 g of 30%-concentration ammonia water were mixed to prepare a mixed solution. The mixed solution was heat to have a temperature of 22° C., and 1,143 g of tetramethoxysilane and 418 g of ammonia water having a concentration of 5.2% by weight were dripped therein at the same time for 2 hrs while stirred. Even after dripping, the mixed solution was stirred for 2 hrs and subjected to cohydrolysis and condensation reactions to prepare an oxidized particulate material (silica) dispersion. After 242 g of hexamethyldisilazane were added into the dispersion at room temperature, the dispersion was heated to have a temperature of 60° C. and subjected to a reaction for 6 hrs to trimethylsilylate the particulate silica. 150 g of dimethyldichlorosilane were further added thereto and the dispersion was subjected to a reaction for 2 hrs. Then, the solvent was removed from the dispersion under reduced pressure to prepare an aggregate of fine powder. The aggregate of fine powder was pulverized by a jet mill and the fine powder was collected by a bug filter to prepare an oxidized particulate material 5.

### (Oxidized Particulate Material 6)

In a 3-litter glass-made reaction vessel equipped with a stirrer, a dripping funnel and a thermometer, 624 g of methanol, 41 g of water and 50 g of 30%-concentration ammonia water were mixed to prepare a mixed solution. The mixed solution was heat to have a temperature of 35° C., and 1,143 g of tetramethoxysilane and 418 g of ammonia water having a concentration of 5.2% by weight were dripped therein at the same time for 4 hrs while stirred. Even after dripping, the mixed solution was stirred for 0.5 hrs and subjected to cohydrolysis and condensation reactions to prepare an oxidized particulate material (silica) dispersion. After 242 g of hexamethyldisilazane were added into the dispersion at room temperature, the dispersion was heated to have a temperature of 60° C. and subjected to a reaction for 3 hrs to trimethylsilylate the particulate silica. Then, the solvent was removed from the dispersion under reduced pressure to prepare an oxidized particulate material 6.

### (Oxidized Particulate Material 7)

In a 3-litter glass-made reaction vessel equipped with a stirrer, a dripping funnel and a thermometer, 624 g of methanol, 41 g of water and 50 g of 30%-concentration ammonia water were mixed to prepare a mixed solution. The mixed solution was heat to have a temperature of 22° C., and 1,143 g of tetramethoxysilane and 418 g of ammonia water having a concentration of 5.2% by weight were dripped therein at the same time for 1 hr while stirred. Even after dripping, the mixed solution was stirred for 1 hr and subjected to cohydrolysis and condensation reactions to prepare an oxidized particulate material (silica) dispersion. After 242 g of hexamethyldisilazane were added into the dispersion at room temperature, the dispersion was heated to have a temperature of 60° C. and subjected to a reaction for 1 hr to trimethylsilylate the particulate silica. Then, the solvent was removed from the dispersion under reduced pressure to prepare an oxidized particulate material 7.

### (Oxidized Particulate Material 8)

Distilled and refined methyltrimethoxysilane was heated and subjected to a bubbling nitrogen gas. The methyltrimethoxysilane was waken by the nitrogen gas to an oxyhydrogen burner to be burned and resolved in the oxyhydrogen flame. The feeding amount of methyltrimethoxysilane was 1,270 g/hr, that of oxygen gas was 2.9 Nm³/hr, that of hydrogen gas was 2.1 Nm³/hr and that of nitrogen gas was 0.58 Nm³/hr. The produced oxidized particulate material was collected by a bug filter. One kg of the oxidized particulate material was fed in a 5-litter Planetary Mixer and 10 g of pure water were added thereto while stirred, and further stirred for 7 hrs at 55° C. after sealed. Next, the oxidized particulate material was cooled to have room temperature and 10 g of hexamethyldisilazane were added thereto while stirred, and further stirred for 12 hrs after sealed. The oxidized particulate material was heated to have a temperature of 115° C. and residual materials and ammonia were removed therefrom while subjected to a nitrogen gas to prepare an aggregate of fine powder. The aggregate of fine powder was pulverized by a jet mill and the fine powder was collected by a bug filter to prepare an oxidized particulate material 8.

### Example 1

683 parts of water, 11 parts of a sodium salt of an adduct of a sulfuric ester with ethyleneoxide methacrylate (ELEMINOL RS-30 from Sanyo Chemical Industries, Ltd.), 83 parts of styrene, 166 parts of methacrylate, 110 parts of butylacrylate and 1 part of persulfate ammonium were mixed in a reactor vessel including a stirrer and a thermometer, and the mixture was stirred for 30 min at 3,800 rpm to prepare a white emulsion therein. The white emulsion was heated to have a temperature of 75° C. and reacted for 3 hrs. Further, 30 parts of an aqueous solution of persulfate ammonium having a concentration of 1% were added thereto and the mixture was reacted at 70° C. for 5 hrs to prepare an aqueous dispersion a [particulate dispersion liquid 1] of a vinyl resin (a copolymer of a sodium salt of an adduct of styrene-methacrylate-butylacrylate-sulfuric ester with ethyleneoxide methacrylate). The [particulate dispersion liquid 1] was measured by LA-920 to find a volume-average particle diameter thereof was 75 nm. A part of the [particulate dispersion liquid 1] was dried to isolate a resin component therefrom. The resin component had a Tg of 60° C. and a weight-average molecular weight of 110,000.

990 parts of water, 83 parts of the [particulate dispersion liquid 1], 37 parts of an aqueous solution of sodium dodecyldiphenyletherdisulfonate having a concentration of 48.5% (ELEMINOLMON-7 from Sanyo Chemical Industries, Ltd.) and 90 parts of ethyl acetate were mixed and stirred to prepare a lacteous liquid an [aqueous phase 1].

229 parts of an adduct of bisphenol A with 2 moles of ethyleneoxide, 529 parts of an adduct of bisphenol A with 3 moles of propyleneoxide, 208 parts terephthalic acid, 46 parts of adipic acid and 2 parts of dibutyltinoxide were polycondensated in a reactor vessel including a cooling pipe, a stirrer and a nitrogen inlet pipe at a normal pressure and 230° C. for 7 hrs. Further, after the mixture was depressurized by 10 to 15 mm Hg and reacted for 5 hrs, 44 parts of trimellitic acid anhydride were added thereto and the mixture was reacted at a normal pressure and 180° C. for 3 hrs to prepare a [low-molecular-weight polyester 1]. The [low-molecular-weight polyester 1] had a number-average molecular weight of 2,300, a weight-average molecular weight of 6,700, a Tg of 43° C. and an acid value of 25.

682 parts of an adduct of bisphenol A with 2 moles of ethyleneoxide, 81 parts of an adduct of bisphenol A with 2 moles of propyleneoxide, 283 parts terephthalic acid, 22 parts of trimellitic acid anhydride and 2 parts of dibutyltinoxide were mixed and reacted in a reactor vessel including a cooling pipe, a stirrer and a nitrogen inlet pipe at a normal pressure and 230° C. for 7 hrs. Further, after the mixture was depressurized to 10 to 5 mmHg and reacted for 5 hrs to prepare an [intermediate polyester 1]. The [intermediate polyester 1] had a number-average molecular weight of 2,200, a weight-average molecular weight of 9,700, a Tg of 54° C. and an acid value of 0.5 and a hydroxyl value of 52. Next, 410 parts of the [intermediate polyester 1], 89 parts of isophoronediisocyanate and 500 parts of ethyl acetate were reacted in a reactor vessel including a cooling pipe, a stirrer and a nitrogen inlet pipe for 5 hrs at 100° C. to prepare a [prepolymer 1]. The [prepolymer 1] included a free isocyanate in an amount of 1.53% by weight. 170 parts of isophoronediamine and 75 parts of methyl ethyl ketone were reacted at 50° C. for 4 hrs and a half in a reaction vessel including a stirrer and a thermometer to prepare a [ketimine compound 1]. The [ketimine compound 1] had an amine value of 417.

600 parts of water, 1,200 parts of Pigment Blue 15:3 aqueous cake including a solid content of 50% by weight and 1,200 parts of a polyester resin were mixed by a Henschel Mixer from Mitsui Mining Co., Ltd. After the mixture was kneaded by a two-roll mill having a surface temperature of 120° C. for 45 min, the mixture was extended by applying pressure, cooled and pulverized by a pulverizer to prepare a [masterbatch 1].

378 parts of the [low-molecular-weight polyester 1], 100 parts of carnauba wax and 947 parts of ethyl acetate were mixed in a reaction vessel including a stirrer and a thermometer. The mixture was heated to have a temperature of 80° C. while stirred. After the temperature of 80° C. was maintained for 5 hrs, the mixture was cooled to have a temperature of 30° C. in an hour. Then, 500 parts of the [masterbatch 1] and 500 parts of ethyl acetate were added to the mixture and mixed for 1 hr to prepare a [material solution 1].

1,324 parts of the [material solution 1] were transferred into another vessel, and the carbon black and wax therein were dispersed by a beads mill (Ultra Visco Mill from IMECS CO., LTD.) for 3 passes under the following conditions:

liquid feeding speed of 1 kg/hr; peripheral disc speed of 6 m/sec; and filling zirconia beads having diameter of 0.5 mm for 80% by volume.

Next, 1,324 parts of an ethyl acetate solution of the [low-molecular-weight polyester 1] having a concentration of 65% were added to the [material solution 1] and the mixture was stirred by the beads mill for 2 passes under the same conditions to prepare a [pigment and wax dispersion liquid ]. The [pigment and wax dispersion liquid 1] had a solid content concentration of 50% when dispersed at 130° C. for 30 min.

749 parts of the [pigment and wax dispersion liquid 1], 115 parts of the [prepolymer 1] and 2.9 parts of the [ketimine compound 1] were mixed in a vessel by a TK-type homomixer from Tokushu Kika Kogyo Co., Ltd. at 5,000 rpm for 2 min. 1,200 parts of the [aqueous phase 1] were added to the mixture and mixed by the TK-type homomixer at 13,000 rpm for 25 min to prepare an [emulsified slurry 1].

The [emulsified slurry 1] was put in a vessel including a stirrer and a thermometer. After a solvent was removed from the emulsified slurry 1 at 30° C. for 8 hrs, the slurry was aged at 45° C. for 7 hrs to prepare a [dispersion slurry 1].

After the [dispersion slurry 1] was filtered under reduced pressure, 100 parts of ion-exchange water were added to the filtered cake and mixed by the TK-type homomixer at 12,000 rpm for 10 min, and the mixture was filtered.

Further, 100 parts of an aqueous solution of 10% sodium hydrate were added to the filtered cake and mixed by the TK-type homomixer at 12,000 rpm for 30 min, and the mixture was filtered under reduced pressure.

Further, 100 parts of 10% hydrochloric acid were added to the filtered cake and mixed by the TK-type homomixer at 12,000 rpm for 10 min, and the mixture was filtered.

Further, 300 parts of ion-exchange water were added to the filtered cake and mixed by the TK-type homomixer at 12,000 rpm for 10 min, and the mixture was filtered. This operation was repeated again to prepare a [filtered cake 1].

The [filtered cake 1] was dried by an air drier at 45° C. for 48 hrs to prepare a mother toner.

In a tank containing water medium wherein the following fluorine-containing compound (2) was dispersed in an amount of 1% by weight, the fluorine-containing compound (2) was mixed with the mother toner so as to adhere thereto in an amount of 0.1% by weight based on total weight thereof.

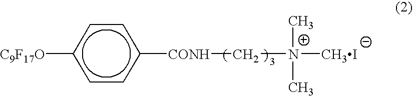

The mother toner was dried by an air drier at 45° C. for 48 hrs, and further dried at 30° C. for 10 hrs on a shelf, and sieved by a mesh having an opening of 75 μm to prepare [mother toner particles 1].

After 100 parts of the [mother toner particles 1] were left in an environment having a temperature of 50° C. for 24 hrs such that the surface thereof were aged, 1.0 part of the oxidized particulate material 1 was mixed therewith by a Henschel Mixer FM20C from Mitsui Mining Co., Ltd, at a peripheral speed of 30 m/sec for 120 sec and paused for 60 sec for 7 times, to prepare a toner.

Seven parts of the toner and 100 parts of carrier 1 were uniformly mixed with a Turbular Mixer rotating the container to mix materials therein to prepare a charged developer. The properties of the toner are shown in Table 1, and the evaluation results thereof are shown in Table 2.

### Example 2

The procedure for preparation and evaluation of the toner and developer in Example 1 were repeated except for changing the process of preparing an oil phase and the following processes as follows to prepare another toner particles 2. The properties of the toner are shown in Table 1, and the evaluation results thereof are shown in Table 2.

378 parts of the [low-molecular-weight polyester 1], 100 parts of carnauba wax and 947 parts of ethyl acetate were mixed in a reaction vessel including a stirrer and a thermometer. The mixture was heated to have a temperature of 80° C. while stirred. After the temperature of 80° C. was maintained for 5 hrs, the mixture was cooled to have a temperature of 30° C. in an hour. Then, 500 parts of the [masterbatch 1] and 500 parts of ethyl acetate were added to the mixture and mixed for 1 hr to prepare a [material solution 1].

1,324 parts of the [material solution 1] were transferred into another vessel, and the carbon black and wax therein were dispersed by a beads mill (Ultra Visco Mill from IMECS CO., LTD.) for 2 passes under the following conditions:

liquid feeding speed of 1 kg/hr; peripheral disc speed of 6 m/sec; and filling zirconia beads having diameter of 0.5 mm for 80% by volume.

Next, 1,324 parts of an ethyl acetate solution of the [low-molecular-weight polyester 1] having a concentration of 65% were added to the [material solution 1] and the mixture was stirred by the beads mill for 2 passes under the same conditions to prepare a [pigment and wax dispersion liquid 1]. The [pigment and wax dispersion liquid 1] had a solid content concentration of 50% when dispersed at 130° C. for 30 min. 749 parts of the [pigment and wax dispersion liquid 1], 115 parts of the [prepolymer 1] and 2.9 parts of the [ketimine compound 1] were mixed in a vessel by a TK-type homomixer from Tokushu Kika Kogyo Co., Ltd. at 5,000 rpm for 2 min. 1,200 parts of the [aqueous phase 1] were added to the mixture and mixed by the TK-type homomixer at 13,000 rpm for 15 min to prepare an [emulsified slurry 1].

The [emulsified slurry 1] was put in a vessel including a stirrer and a thermometer. After a solvent was removed from the emulsified slurry 1 at 30° C. for 8 hrs, the slurry was aged at 45° C. for 5 hrs to prepare a [dispersion slurry 1].

After the [dispersion slurry 1] was filtered under reduced pressure, 100 parts of ion-exchange water were added to the filtered cake and mixed by the TK-type homomixer at 12,000 rpm for 10 min, and the mixture was filtered.

Further, 100 parts of an aqueous solution of 10% sodium hydrate were added to the filtered cake and mixed by the TK-type homomixer at 12,000 rpm for 30 min, and the mixture was filtered under reduced pressure.

Further, 100 parts of 10% hydrochloric acid were added to the filtered cake and mixed by the TK-type homomixer at 12,000 rpm for 10 min, and the mixture was filtered.

Further, 300 parts of ion-exchange water were added to the filtered cake and mixed by the TK-type homomixer at 12,000 rpm for 10 min, and the mixture was filtered. This operation was repeated again to prepare a [filtered cake 1].

The [filtered cake 1] was dried by an air drier at 45° C. for 48 hrs to prepare a mother toner.

In a tank containing water medium wherein the following fluorine-containing compound (2) was dispersed in an amount of 1% by weight, the fluorine-containing compound (2) was mixed with the mother toner so as to adhere thereto in an amount of 0.1% by weight based on total weight thereof.

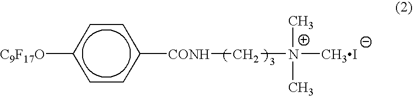

The mother toner was dried by an air drier at 45° C. for 48 hrs, and further dried at 30° C. for 10 hrs in a shelf, and sieved by a mesh having an opening of 75 μm to prepare [mother toner particles 2].

### Example 3

The procedure for preparation and evaluation of the toner and developer in Example 1 were repeated except for replacing the oxidized particulate material 1 added to the mother toner particles 1 with the oxidized particulate material 2. The properties of the toner are shown in Table 1, and the evaluation results thereof are shown in Table 2.

### Example 4

The procedure for preparation and evaluation of the toner and developer in Example 1 were repeated except for replacing the oxidized particulate material 1 added to the mother toner particles 1 with the oxidized particulate material 3. The properties of the toner are shown in Table 1, and the evaluation results thereof are shown in Table 2.

### Example 5

The procedure for preparation and evaluation of the toner and developer in Example 1 were repeated except for replacing the oxidized particulate material 1 added to the mother toner particles 1 with the oxidized particulate material 4. The properties of the toner are shown in Table 1, and the evaluation results thereof are shown in Table 2.

### Example 6

The procedure for preparation and evaluation of the toner and developer in Example 1 were repeated except for replacing the oxidized particulate material 1 added to the mother toner particles 1 with the oxidized particulate material 5. The properties of the toner are shown in Table 1, and the evaluation results thereof are shown in Table 2.

### Example 7

The procedure for preparation and evaluation of the toner and developer in Example 1 were repeated except for changing the process of mixing the oxidized particulate material 1 with the mother toner particles 1 and the following processes as follows.

After 100 parts of the [mother toner particles 1] were left in an environment having a temperature of 50° C. for 24 hrs such that the surface thereof were aged, 1.0 part of the oxidized particulate material 1 and 1.0 parts of a hydrophobic silica RX200 having a primary particle diameter of 12 nm from Nippon Aerosil Co., Ltd. were mixed therewith by a Henschel Mixer FM20C from Mitsui Mining Co., Ltd, at a peripheral speed of 30 m/sec for 120 sec and paused for 60 sec for 7 times, to prepare a toner.

Seven parts of the toner and 100 parts of carrier 1 were uniformly mixed with a Turbular Mixer rotating the container to mix materials therein to prepare a charged developer. The properties of the toner are shown in Table 1, and the evaluation results thereof are shown in Table 2.

### Example 8

The procedure for preparation and evaluation of the toner and developer in Example 1 were repeated except for using the following mother toner particles 3 instead of the mother toner particles 1. The properties of the toner are shown in Table 1, and the evaluation results thereof are shown in Table 2.

The following materials were mixed, dissolved, dispersed and emulsified in a flask including 550 g of ion-exchange water including 6 g of a dissolved nonionic surfactant Nonipol 400 from Sanyo Chemical Industries, Ltd. and 10 g of a dissolved anionic surfactant Neogen SC from Dai-ichi Kogyo Seiyaku Co., Ltd.

| | | |
|---|---|---|
| Styrene | 370 | g |
| N-butylacrylate | 30 | g |
| Acrylic acid | 8 | g |
| Dodecanethiol | 24 | g |
| Carbon tetrabromide | 4 | g |

After 50 g of ion-exchange water including 4 g of dissolved ammonium persulfate were put in the emulsified mixture to perform a nitrogen substitution while slowly mixed for 10 min, the mixture in the flask was heated to have a temperature of 70° C. with an oil bath while stirred and the emulsion polymerization was continued for 5 hrs. Thus, a dispersion liquid (1) including a dispersed resin particle having an average particle diameter of 155 nm, a Tg of 59° C. and a weight-average molecular weight of 12,000 was prepared.

The following materials were mixed, dissolved, dispersed and emulsified in a flask including 550 g of ion-exchange water including 6 g of a dissolved nonionic surfactant Nonipol 400 from Sanyo Chemical Industries, Ltd. and 12 g of a dissolved anionic surfactant Neogen SC from Dai-ichi Kogyo Seiyaku Co., Ltd.

| | |
|---|---|
| Styrene | 280 g |
| N-butylacrylate | 120 g |
| Acrylic acid | 8 g |

After 50 g of ion-exchange water including 3 g of dissolved ammonium persulfate were put in the emulsified mixture to perform a nitrogen substitution while slowly mixed for 10 min, the mixture in the flask was heated to have a temperature of 70° C. with an oil bath while stirred and the emulsion polymerization was continued for 5 hrs. Thus, a dispersion liquid (2) including a dispersed resin particle having an average particle diameter of 105 nm, a Tg of 53° C. and a weight-average molecular weight of 550,000 was prepared.

The following materials were mixed, dissolved and dispersed by a homogenizer T50 from IKA-WERKE GMBH & CO., KG. for 10 min to prepare a colorant dispersion liquid (1) including a colorant (carbon black) having an average particle diameter of 250 nm.

| | |
|---|---|
| Carbon black | 50 g |
| (Mogal L from Cabot Corp.) | |
| Nonionic surfactant | 5 g |
| (Nonipol 400 from Sanyo Chemical Industries, Ltd. | |
| Ion-exchange water | 200 g |

After the following materials were heated at 95° C. and dispersed by a homogenizer T50 from IKA-WERKE GMBH & CO., KG., the mixture was dispersed by a pressure discharging homogenizer to prepare a release agent dispersion liquid (1) including a release agent having an average particle diameter of 550 nm.

| | |
|---|---|
| Paraffin wax | 50 g |
| (HNP0190 having a melting point of 85° C. | |
| from Nippon Seiro Co., Ltd.) | |
| Cationic surfactant | 7 g |
| (Sanisol B50 from Kao Corp.) | |
| Ion-exchange water | 200 g |

After the following materials were mixed and dispersed by homogenizer T50 from IKA-WERKE GMBH & CO., KG. in a round stainless flask, the mixture was heated to have a temperature of 40° C. while stirred in a heating oil bath.

| | | |
|---|---|---|
| Dispersion liquid (1) | 120 | g |
| Dispersion liquid (2) | 80 | g |
| Colorant dispersion liquid (1) | 30 | g |
| Release agent dispersion liquid (1) | 40 | g |
| Cationic surfactant | 1.5 | g |
| (Sanisol B50 from Kao Corp.) | | |

After the mixture was maintained to have the temperature of 40° C. for 30 min, the mixture was observed by an optical microscope to find that agglomerated particles having an average particle diameter of about 5 μm were formed.

Further, 60 g of the dispersion liquid (1) were gradually added into the mixture. The resin particles included in the dispersion liquid (1) had a volume of 25 cm³. Then, the mixture was left for 1 hr after the temperature of the heating oil bath was raised to 50° C.

Then, after 3 g of the anionic surfactant Neogen SC from Dai-ichi Kogyo Seiyaku Co. were added into the mixture, the mixture was closed in the stainless flask and heated to have a temperature of 105° C. while stirred with a magnetic seal for 3 hrs. Then, after the mixture was cooled, a reaction product was filtered, fully washed with ion-exchange water and dried to prepare a toner particle 3.

### Comparative Example 1

The procedure for preparation and evaluation of the toner and developer in Example 1 were repeated except for using the following mother toner particles 4 instead of the mother toner particles 1. The properties of the toner are shown in Table 1, and the evaluation results thereof are shown in Table 2.

The following materials were stirred by a flasher to prepare a mixture.

| | |
|---|---|
| Water | 1,200 |
| Phthalocyanine Green aqueous cake | 200 |
| (including a solid content of 30%) | |
| Carbon black | 540 |
| (MA60 from Mitsubishi Chemical Corp.) | |

1,200 parts of a polyester resin having an acid value of 3, a hydroxyl value of 25, a number-average molecular weight of 45,000, a ratio of a weight-average molecular weight to the number-average molecular weight of 4.0 and a glass transition temperature of 60° C. were added to the mixture, and which was kneaded at 150° C. for 30 min to prepare a kneaded mixture. 1,000 parts of xylene were added to the kneaded mixture, and which was further kneaded for 1 hr. After water and xylene were removed from the kneaded mixture, it was extended upon application of pressure and cooled to prepare a solid material. The solid material was pulverized by a pulverizer to prepare a masterbatch pigment.

The following materials were mixed by a mixer to prepare a mixture.

| | |
|---|---|
| Polyester resin | 100 |
| having an acid value of 3, a hydroxyl value of 25, a | |
| number-average molecular weight of 45,000, a ratio of a | |
| weight-average molecular weight to the number-average molecular | |
| weight of 4.0 and a glass transition temperature of 60° C. | |
| The masterbatch pigment | 5 |
| Charge controlling agent | 2 |
| Bontron E-84 from Orient Chemical Industries, Ltd. | |

The mixture was melted and kneaded by a two-roll mill to prepare a kneaded mixture, and which was extended upon application of pressure and cooled to prepare a solid material. The solid material was pulverized by a jet mill pulverizer using a collision board (I-2 type mill from Nippon Pneumatic Mfg. Co., Ltd., and the pulverized mixture was classified by a wind force classifier using a swirling flow (DS classifier from Nippon Pneumatic Mfg. Co., Ltd.) to prepare mother toner particles 4.

### Comparative Example 2

The procedure for preparation and evaluation of the toner and developer in Example 1 were repeated except for using the following mother toner particles 5 instead of the mother toner particles 1. The properties of the toner are shown in Table 1, and the evaluation results thereof are shown in Table 2.

The following materials were stirred by a flasher to prepare a mixture.

| | |
|---|---|
| Water | 600 |
| Pigment Blue 15:3 aqueous cake | 1,200 |
| having a solid content of 50% | |

1,200 parts of a polyester resin having an acid value of 3, a hydroxyl value of 25, a number-average molecular weight of 45,000, a ratio of a weight-average molecular weight to the number-average molecular weight of 4.0 and a glass transition temperature of 60° C. were added to the mixture, and which was kneaded at 150° C. for 30 min to prepare a kneaded mixture. 1,000 parts of xylene were added to the kneaded mixture, and which was further kneaded for 1 hr. After water and xylene were removed from the kneaded mixture, it was extended upon application of pressure and cooled to prepare a solid material. The solid material was pulverized by a pulverizer and further subjected to two passes of three-roll mill to prepare a master batch pigment.

The following materials were mixed by a mixer to prepare a mixture.

| | |
|---|---|
| Polyester resin | 100 |
| having an acid value of 3, a hydroxyl value of 25, a | |
| number-average molecular weight of 45,000, a ratio of a | |
| weight-average molecular weight to the number-average | |
| molecular weight of 4.0 and a glass transition | |
| temperature of 60° C. | |
| The masterbatch pigment | 3 |
| Charge controlling agent | 4 |
| Bontron E-84 from Orient Chemical Industries, Ltd. | |

The mixture was melted and kneaded by a two-roll mill to prepare a kneaded mixture, and which was extended upon application of pressure and cooled to prepare a solid material. The solid material was pulverized by a jet mill pulverizer using a collision board (I-2 type mill from Nippon Pneumatic Mfg. Co., Ltd., and the pulverized mixture was classified by a wind force classifier using a swirling flow (DS classifier from Nippon Pneumatic Mfg. Co., Ltd.) to prepare mother toner particles. Then, the mother toner particles were left on a shelf at 65° C. for 24 hrs such that the surfaces thereof were spheronized, and classified again by a wind force classifier (DS classifier from Nippon Pneumatic Mfg. Co., Ltd.) to prepare mother toner particles 5.

### Comparative Example 3

The procedure for preparation and evaluation of the toner and developer in Example 1 were repeated except for changing the process of mixing the mother toner particles 1 with the oxidized particulate material 1 as follows. The properties of the toner are shown in Table 1, and the evaluation results thereof are shown in Table 2.

100 parts of the [mother toner particles 1] (without aging the surface thereof) and 1.0 part of the oxidized particulate material 1 were mixed by a Henschel Mixer FM20C from Mitsui Mining Co., Ltd, at a peripheral speed of 20 m/sec for 60 sec and paused for 30 sec for 2 times, to prepare a toner.

Seven parts of the toner and 100 parts of carrier 1 were uniformly mixed with a Turbular Mixer rotating the container to mix materials therein to prepare a charged developer.

### Comparative Example 4

The procedure for preparation and evaluation of the toner and developer in Example 1 were repeated except for replacing the oxidized particulate material 1 added to the mother toner particles 1 with the oxidized particulate material 6. The properties of the toner are shown in Table 1, and the evaluation results thereof are shown in Table 2.

### Comparative Example 5

The procedure for preparation and evaluation of the toner and developer in Example 1 were repeated except for replacing the oxidized particulate material 1 added to the mother toner particles 1 with the oxidized particulate material 7. The properties of the toner are shown in Table 1, and the evaluation results thereof are shown in Table 2.

### Comparative Example 6

The procedure for preparation and evaluation of the toner and developer in Example 1 were repeated except for replacing the oxidized particulate material 1 added to the mother toner particles 1 with the oxidized particulate material 8. The properties of the toner are shown in Table 1, and the evaluation results thereof are shown in Table 2.

TABLE 1

| | T | | | | ST. of OPM | | | | | |
|---|---|---|---|---|---|---|---|---|---|---|
| | D4 | C | MTP | OPM | Dn | DL | SF1 | SF1L | SF2 | SF2L |
| Ex. 1 | 4.9 | 0.95 | 1 | 1 | 51 | 5 | 121 | 3 | 110 | 4 |
| Ex. 2 | 4.1 | 0.95 | 2 | 1 | 52 | 6 | 123 | 4 | 112 | 55 |
| Ex. 3 | 4.9 | 0.95 | 1 | 2 | 80 | 6 | 122 | 7 | 115 | 8 |
| Ex. 4 | 4.9 | 0.95 | 1 | 3 | 32 | 8 | 128 | 9 | 124 | 9 |
| Ex. 5 | 4.9 | 0.95 | 1 | 4 | 79 | 9 | 122 | 9 | 122 | 8 |
| Ex. 6 | 4.9 | 0.95 | 1 | 5 | 53 | 8 | 128 | 8 | 124 | 7 |
| Ex. 7 | 4.9 | 0.95 | 1 | 1 | 58 | 8 | 126 | 8 | 122 | 8 |
| Ex. 8 | 6.0 | 0.95 | 3 | 1 | 53 | 5 | 122 | 3 | 110 | 4 |
| Com. | 6.8 | 0.94 | 4 | 1 | 50 | 7 | 119 | 5 | 109 | 7 |
| Ex. 1 | | | | | | | | | | |
| Com. | 7.2 | 0.95 | 5 | 1 | 52 | 5 | 121 | 6 | 116 | 8 |
| Ex. 2 | | | | | | | | | | |
| Com. | 4.9 | 0.95 | 1 | 1 | 78 | 16 | 134 | 16 | 127 | 20 |
| Ex. 3 | | | | | | | | | | |
| Com. | 4.9 | 0.95 | 1 | 6 | 110 | 4 | 120 | 8 | 115 | 9 |
| Ex. 4 | | | | | | | | | | |
| Com. | 4.9 | 0.95 | 1 | 7 | 28 | 8 | 123 | 7 | 120 | 7 |
| Ex. 5 | | | | | | | | | | |
| Com. | 4.9 | 0.95 | 1 | 8 | 52 | 32 | 134 | 41 | 127 | 35 |
| Ex. 6 | | | | | | | | | | |

D4: Weight-Average Particle Diameter (μm)
C: Circularity
MTP: Mother Toner Particle
OPM: Oxidized Particulate Material
St.: Status
Dn: Number-Average Particle Diameter (μm)
DL: Standard Deviation Rate of Particle Diameter Distribution (%)
SF1L: Standard Deviation Rate of shape factor SF1 (%)
SF2L: Standard Deviation Rate of shape factor SF2 (%)

TABLE 2

| | (1) | (2) | (3) | (4) | (5) | (6) | (7) | (8) |
|---|---|---|---|---|---|---|---|---|
| Ex. 1 | ◯ | ◯ | ⊚ | ◯ | ◯ | ◯ | ◯ | ⊚ |
| Ex. 2 | ◯ | Δ | ⊚ | ◯ | ◯ | ⊚ | ◯ | ⊚ |
| Ex. 3 | ⊚ | ⊚ | ◯ | ⊚ | Δ | ◯ | ◯ | ◯ |
| Ex. 4 | Δ | Δ | ⊚ | Δ | ◯ | ⊚ | ◯ | ⊚ |
| Ex. 5 | ◯ | ◯ | ⊚ | ◯ | ⊚ | ◯ | Δ | ⊚ |
| Ex. 6 | ◯ | ◯ | ◯ | Δ | ◯ | ◯ | ⊚ | ⊚ |
| Ex. 7 | ◯ | ⊚ | ⊚ | ◯ | ◯ | ⊚ | ⊚ | ◯ |
| Ex. 8 | ⊚ | ◯ | Δ | ◯ | ◯ | ◯ | ◯ | Δ |
| Com. | ◯ | ⊚ | ⊚ | Δ | X | X | ⊚ | X |
| Ex. 1 | | | | | | | | |
| Com. | ◯ | ⊚ | ⊚ | Δ | X | Δ | ⊚ | X |
| Ex. 2 | | | | | | | | |
| Com. | X | X | ◯ | Δ | Δ | Δ | ◯ | ⊚ |
| Ex. 3 | | | | | | | | |
| Com. | ⊚ | ⊚ | X | X | X | Δ | ◯ | Δ |
| Ex. 4 | | | | | | | | |
| Com. | X | X | ⊚ | Δ | ◯ | ⊚ | ◯ | ⊚ |
| Ex. 5 | | | | | | | | |
| Com. | X | X | ◯ | Δ | X | X | ◯ | ◯ |
| Ex. 6 | | | | | | | | |

This application claims priority and contains subject matter related to Japanese Patent Application No. 2008-023205, filed on Feb. 1, 2008, the entire contents of which are hereby incorporated by reference.

Having now fully described the invention, it will be apparent to one of ordinary skill in the art that many changes and modifications can be made thereto without departing from the spirit and scope of the invention as set forth therein.

What is claimed as new and desired to be secured by letters patent: of the United States is:

1. A toner having a weight-average particle diameter of from 2 to 7 μm and a circularity of from 0.95 to 1.00, comprising:
a colorant;
a binder resin; and
at least one oxidized particulate material, comprising a silicon element,
wherein the oxidized particulate material has a number-average particle diameter (Dn) of from 30 to 80 nm; a standard deviation rate of the particle diameter distribution (the standard deviation/Dn×100) of from 0 to 10%; a shape factor SF1 of from 100 to 130; a standard deviation rate of the SF1 (the standard deviation/SF1×100) of from 0 to 10%; a shape factor SF2 of from 100 to 125; and a standard deviation rate of the SF2 (the standard deviation/SF2×100) of from 0 to 10%.

2. The toner of claim 1, wherein the oxidized particulate material is prepared by a sol-gel method.

3. The toner of claim 1, wherein the oxidized particulate material is hydrophobized with hexamethyldisilazane.

4. The toner of claim 1, further comprising a second oxidized particulate material having a number-average particle diameter less than 30 nm.

5. The toner of claim 1, wherein the binder resin comprises a polyester resin.

6. The toner of claim 1, wherein the toner is prepared by a method comprising:
dispersing toner constituents comprising a compound having an active hydrogen atom, a polymer having a site reatable with the active hydrogen atom, a polyester resin, a colorant and a release agent in an organic solvent to prepare a toner constituents solution; and
dispersing the toner constituents solution in an aqueous medium under the presence of a particulate resin such that the toner constituents are subject to at least one of a crosslinking reaction and an elongation reaction.

7. A two-component developer, comprising a carrier and the toner according to claim 1.

8. The two-component developer of claim 7, wherein the carrier is a magnetic particulate material.

9. An image forming method, comprising:
developing an electrostatic latent image on an electrostatic latent image bearer with the toner according to claim 1 to form a toner image; and
contacting a transferer to the electrostatic latent image bearer through a transfer material to electrostatically transfer the toner image onto the transfer material.

10. An image forming method, comprising:
developing an electrostatic latent image on an electrostatic latent image bearer with the two-component developer according to claim 7 to form a toner image; and
contacting a transferer to the electrostatic latent image bearer through a transfer material to electrostatically transfer the toner image onto the transfer material.

11. An image forming apparatus, comprising:
an electrostatic latent image bearer;
a charger configured to charge the electrostatic latent image bearer;
an irradiator configured to irradiate the electrostatic latent image bearer to form an electrostatic latent image thereon;
an image developer configured to develop the electrostatic latent image with the toner according to claim 1 to form a toner image on the electrostatic latent image bearer;
a transferer configured to transfer the toner image onto a transfer material from the electrostatic latent image bearer; and
a cleaner configured to remove the toner remaining on the electrostatic latent image bearer.

12. An image forming apparatus, comprising:
an electrostatic latent image bearer;
a charger configured to charge the electrostatic latent image bearer;
an irradiator configured to irradiate the electrostatic latent image bearer to form an electrostatic latent image thereon;
an image developer configured to develop the electrostatic latent image with the two-component developer according to claim 7 to form a toner image on the electrostatic latent image bearer;
a transferer configured to transfer the toner image onto a transfer material from the electrostatic latent image bearer; and
a cleaner configured to remove the toner remaining on the electrostatic latent image bearer.

13. A process cartridge, comprising an electrostatic latent image bearer; and at least one of a charger configured to charge the electrostatic latent image bearer;
an image developer configured to develop the electrostatic latent image with the toner according to claim 1; and
a cleaner configured to remove the toner remaining on the electrostatic latent image bearer.

14. A process cartridge, comprising an electrostatic latent image bearer; and at least one of
a charger configured to charge the electrostatic latent image bearer;
an image developer configured to develop the electrostatic latent image with the two-component developer according to claim 7; and
a cleaner configured to remove the toner remaining on the electrostatic latent image bearer.
